(19) United States
(12) Patent Application Publication
(10) Pub. No.: US 2017/0002225 A1
(43) Pub. Date: Jan. 5, 2017

(54) PIGMENT DISPERSION, WHITE DECORATIVE MATERIAL, TRANSFER MATERIAL FOR FORMING WHITE DECORATIVE MATERIAL, SUBSTRATE ATTACHED WITH WHITE DECORATIVE MATERIAL, TOUCH PANEL, AND INFORMATION DISPLAY DEVICE

(71) Applicant: FUJIFILM Corporation, Tokyo (JP)

(72) Inventors: Saori ASADA, Fujinomiya-shi (JP); Takashi ARIDOMI, Fujinomiya-shi (JP)

(73) Assignee: FUJIFILM Corporation, Tokyo (JP)

(21) Appl. No.: 15/264,705

(22) Filed: Sep. 14, 2016

Related U.S. Application Data
(63) Continuation of application No. PCT/JP2015/058179, filed on Mar. 19, 2015.

(30) Foreign Application Priority Data
Mar. 20, 2014 (JP) 2014-058945

(51) Int. Cl. C09D 17/00; C09D 183/04

(52) U.S. Cl. CPC C09D 17/008; C09D 183/04

(57) ABSTRACT

A pigment dispersion containing a pigment dispersing agent having a partial structure denoted by General Formula 1 described below and a pigment adsorption portion in the same molecule, a white pigment, and any one of a hydrocarbon-based solvent, a ketone-based solvent, an ester-based solvent, and an alcohol-based solvent (in General Formula 1, R¹ and R² each independently represent an alkyl group having 1 to 4 carbon atoms, an alkoxyl group having 1 to 2 carbon atoms, or a hydrogen atom, and n represents a natural number), in which a white coated film having glossiness is obtained, and a b value of the coated film after being subjected to a high temperature treatment decreases; a white decorative material and a substrate attached with a white decorative material using the pigment dispersion, a transfer material for forming a white decorative material and a touch panel using the white decorative material and a substrate attached with a white decorative material, and the transfer material for forming a white decorative material; and an information display device using the touch panel.

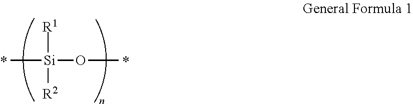

### CROSS-REFERENCE TO RELATED APPLICATIONS

This application is a Continuation of PCT International Application No. PCT/JP2015/058179, filed on Mar. 19, 2015, which claims priority under 35 U.S.C. Section 119(a) to Japanese Patent Application No. 2014-058945 filed on Mar. 20, 2014. Each of the above applications is hereby expressly incorporated by reference, in its entirety, into the present application.

### BACKGROUND OF THE INVENTION

1. Field of the Invention

The present invention relates to a pigment dispersion. Further, the present invention relates to a white decorative material and a transfer material for forming a white decorative material using the pigment dispersion, and a substrate attached with a white decorative material using the white decorative material, and a touch panel using the white decorative material and the transfer material for forming a white decorative material, and the substrate attached with a white decorative material. In addition, the present invention relates to an information display device including the touch panel.

2. Description of the Related Art

In electronic devices such as a mobile phone, a car navigation system, a personal computer, a ticket machine, and a terminal of a bank, recently, a touch panel type input device has been arranged on the surface of a liquid crystal device or the like, and a finger, a touch pen, or the like has been brought into contact with a portion in which an instruction image is displayed with reference to an instruction image displayed on an image display region of the liquid crystal device, and thus, information corresponding to the instruction image has been input.

Examples of such an input device (a touch panel) include a resistance film type input device, an electrostatic capacitance type input device, and the like. The electrostatic capacitance type input device has an advantage of simply forming a light transmitting conductive film on one substrate. In an electrostatic capacitance type touch panel of a touch panel integrated with cover glass (OGS: One Glass Solution), a front plate is integrated with the electrostatic capacitance type input device, and thus, a reduction in thickness/weight is able to be obtained.

In such an electrostatic capacitance type input device, in order to make a routing circuit or the like of the display device invisible to a user and to have a good appearance, a decorative material is formed into the shape of a frame surrounding an information display unit (also referred to as an image display unit and a light transmitting region) which comes into contact with a finger, a touch pen, or the like, and decoration is performed. A white decorative material has been required as a decorative material for performing such decoration from the viewpoint of a design and a good appearance.

When a colored member such as a white decorative material is manufactured, in general, a method using a pigment dispersion is known. A polymer compound is added to the pigment dispersion as a pigment dispersing agent in order to increase the dispersibility of the pigment. An example in which a polymer having a polysiloxane partial structure is used is known as such a pigment dispersing agent.

For example, in JP1993-255433A (JP-H05-255433A), it is disclosed that a non-aqueous silicon-containing polymer which is easily dissolved or dispersed in a solvent having a low SP value, such as silicone oil or a fluorine-based solvent, a non-aqueous resin dispersion containing the polymer, and a manufacturing method thereof are provided by a silicon-containing polymer having a specific polysiloxane partial structure. In the example of JP1993-255433A (JP-H05-255433A), an example is disclosed in which such a non-aqueous silicon-containing polymer, and carbon black as a pigment are dispersed in silicone oil.

In JP2013-43962A, it is disclosed that dispersibility and dispersion stability increase by a coloring agent-containing particle dispersion which includes a coloring agent-containing particles containing at least a coloring agent and a polymer with a polymer skeleton having an Si atom, and a dispersion medium. In JP2013-43962A, examples of a dispersion medium include at least one selected from silicone oil and paraffin-based hydrocarbon. In the example of JP2013-43962A, an example is disclosed in which a magenta or cyan coloring agent is used, a polymer with a polymer skeleton having an Si atom is dispersed in silicone oil, and moisture is removed.

In JP2012-88934A, an image display particle dispersion containing a polymer dispersing agent, and a dispersion medium including silicone oil, in which a polymer dispersing agent for an image display particles formed of a copolymer of a polymerization component having a silicone chain, a hydrophobic polymerization component excluding the polymerization component having a silicone chain, and a polymerization component having a polyalkylene glycol structure is attached onto the surface of an image display particle main body, is disclosed. In JP2012-88934A, it is disclosed that dispersion stability increases by such an image display particle dispersion. In the example of JP2012-88934A, an example is disclosed in which a cyan pigment is used, a polymer including a polymerization component having a silicone chain is dispersed in silicone oil, and moisture or t-butanol is removed.

### SUMMARY OF THE INVENTION

However, as a result of intensive studies of the present inventors, it has been newly found that in a case where the white decorative material is manufactured by using the pigment dispersion containing the white pigment, a problem occurs on the appearance of the coated film. In a case where silicone oil or the like as used in JP1993-255433A (JP-H05-255433A), JP2013-43962A, and JP2012-88934A is used alone as a dispersion medium, it is found that the surface of the coated film is roughened without having glossiness, and the color is changed to an ash gray color.

Further, as a result of intensive studies of the present inventors, in a case where the white decorative material is manufactured by using the pigment dispersion containing the white pigment, it has been newly found that a problem of coloring occurs in a high temperature treatment step at the time of manufacturing a front plate-integrated touch panel. Here, in JP1993-255433A (JP-H05-255433A), the problem of coloring in the high temperature treatment step is not disclosed or indicated, and in the example of JP1993-255433A (JP-H05-255433A), carbon black is used as a pigment, and thus, it is not possible to recognize the problem of coloring in the high temperature treatment step even with reference to JP1993-255433A (JP-H05-255433A). In addition, in JP2013-43962A and JP2012-88934A, the problem of coloring in the high temperature treatment step is also not disclosed or indicated.

The present invention has been made in order to simultaneously solve the two types of problems described above, and an object of the present invention is to provide a pigment dispersion in which a white coated film having glossiness is obtained, and a b value of the coated film after being subjected to a high temperature treatment decreases.

As a result of intensive studies of the present inventors for attaining the object described above, it has been found that it is possible to make obtaining a white coated film having glossiness by using a white pigment, a pigment dispersing agent having a pigment adsorption portion and a polysiloxane partial structure in the same molecule, and a specific solvent together, and decreasing a b value of the coated film after being subjected to a high temperature treatment compatible, and thus, the present invention has been completed.

Specifically, the present invention has the following configurations.

[1] A pigment dispersion, containing: a pigment dispersing agent having a partial structure denoted by General Formula 1 described below and a pigment adsorption portion in the same molecule; a white pigment; and any one of a hydrocarbon-based solvent, a ketone-based solvent, an ester-based solvent, and an alcohol-based solvent.

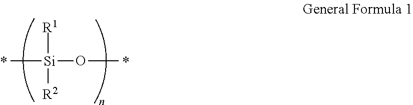

In General Formula 1, R¹ and R² each independently represent an alkyl group having 1 to 4 carbon atoms, an alkoxyl group having 1 to 2 carbon atoms, or a hydrogen atom, and n represents a natural number.

[2] In the pigment dispersion according to [1], it is preferable that the pigment dispersing agent has a copolymer which contains at least a copolymerization component having the partial structure denoted by General Formula 1 described above and a copolymerization component having the pigment adsorption portion, and a structure denoted by General Formula 2 described below, or a structure denoted by General Formula 3 described below.

(A¹-R⁴)ₗ—R³—(R⁵—P¹)ₘ General Formula 2

A¹-R⁵—P¹ General Formula 3

In General Formulas 2 and 3, R³ represents an (m+l)-valent organic linking group, R⁴ and R⁵ each independently represent a single bond or a divalent linking group, A¹ represents an organic group having a pigment adsorption portion or a hydrogen atom, P¹ represents a structure having the partial structure denoted by General Formula 1 described above, m represents 1 to 8, and 1 represents 1 to 10.

[3] In the pigment dispersion according to [1] or [2], it is preferable that a content of the partial structure denoted by General Formula 1 described above in the pigment dispersing agent is greater than or equal to 50 mass %.

[4] In the pigment dispersion according to any one of [1] to [3], it is preferable that the pigment adsorption portion includes at least one portion selected from an acidic group, a group having a basic nitrogen atom, a urea group, a urethane group, a group having a coordinating oxygen atom, a hydrocarbon group having greater than or equal to 4 carbon atoms, a heterocyclic residue, an amide group, an alkoxy silyl group, an epoxy group, an isocyanate group, a hydroxyl group, and a thiol group.

[5] In the pigment dispersion according to any one of [1] to [4], it is preferable that the white pigment is titanium oxide.

[6] It is preferable that the pigment dispersion according to any one of [1] to [5] further contains a silicone resin.

[7] In the pigment dispersion according to any one of [1] to [6], it is preferable that the pigment dispersion is used for forming a white decorative material.

[8] A white decorative material using the pigment dispersion according to any one of [1] to [7].

[9] A transfer material for forming a white decorative material, comprising: a white colored layer using the pigment dispersion according to any one of [1] to [7].

[10] A substrate attached with a white decorative material, comprising: the white decorative material according to [8]; and a substrate.

[11] A touch panel, comprising: the white decorative material according to [8]; and the white decorative material using the transfer material for forming a white decorative material according to [9] or the substrate attached with a white decorative material according to [10].

[12] An information display device, comprising: the touch panel according to [11].

According to the present invention, it is possible to provide a pigment dispersion in which a white coated film having glossiness is obtained, and a b value of the coated film after being subjected to a high temperature treatment decreases.

According to the present invention, it is possible to provide a white decorative material and a substrate attached with a white decorative material using the pigment dispersion of the present invention, and a transfer material for forming a white decorative material and a touch panel using the transfer material for forming a white decorative material. In addition, it is possible to provide an information display device including the touch panel.

### BRIEF DESCRIPTION OF THE DRAWINGS

FIG. 1 is a partially enlarged sectional view illustrating an example of a white decorative material.

FIG. 2 is a partially enlarged sectional view illustrating another example of the white decorative material.

FIG. 3 is a partially enlarged sectional view illustrating still another example of the white decorative material.

FIG. 4 is a partially enlarged sectional view illustrating a tilt angle between a tilt portion and a substrate.

FIG. 5 is a schematic sectional view illustrating a configuration of an example of a touch panel of the present invention using a substrate attached with a white decorative material of the present invention.

FIG. 6 is a schematic sectional view illustrating a configuration of another example of the touch panel of the present invention using the substrate attached with a white decorative material of the present invention.

FIG. 7 is an explanatory diagram illustrating an example of a front plate of the touch panel of the present invention.

FIG. 8 is an explanatory diagram illustrating an example of a first transparent electrode pattern and a second transparent electrode pattern of the touch panel of the present invention.

FIG. 9 is a top view illustrating an example of reinforced glass in which an opening portion is formed.

FIG. 10 is a top view illustrating an example of a touch panel of the present invention in which a white decorative material and a light shielding layer are formed.

FIG. 11 is a top view illustrating an example of a touch panel of the present invention in which a first transparent electrode pattern is formed.

FIG. 12 is a top view illustrating an example of a touch panel of the present invention in which a first transparent electrode pattern and a second transparent electrode pattern are formed.

FIG. 13 is a top view illustrating an example of a touch panel of the present invention in which a conductive element is formed separately from the first transparent electrode pattern and the second transparent electrode pattern.

### DESCRIPTION OF THE PREFERRED EMBODIMENTS

Hereinafter, a pigment dispersion, a white decorative material, a substrate attached with a white decorative material, a transfer material for forming a white decorative material, a touch panel, and an information display device of the present invention will be in detail described.

The following description of configuration requirements is based on representative embodiments of the present invention, but the present invention is not limited to the embodiments. Furthermore, herein, a numerical range denoted by using “to” indicates a range including numerical values before and after “to” as the lower limit value and the upper limit value.

[Pigment Dispersion]

A pigment dispersion of the present invention includes a pigment dispersing agent having a partial structure denoted by General Formula 1 described below and a pigment adsorption portion in the same molecule, a white pigment, and any one of a hydrocarbon-based solvent, a ketone-based solvent, an ester-based solvent, and an alcohol-based solvent.

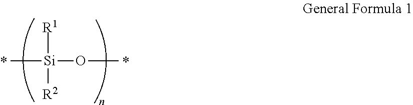

In General Formula 1, R¹ and R² each independently represent an alkyl group having 1 to 4 carbon atoms, an alkoxyl group having 1 to 2 carbon atoms, or a hydrogen atom, and n represents a natural number.

According to such a configuration, a pigment dispersion is obtained in which a white coated film having glossiness is obtained, and a b value of the coated film after being subjected to a high temperature treatment decreases.

<Molecular Structure of Pigment Dispersing Agent>

The pigment dispersing agent described above has the partial structure denoted by General Formula 1 described above and the pigment adsorption portion in the same molecule.

It is preferable that the pigment dispersing agent described above has a copolymer which contains at least a copolymerization component having the partial structure denoted by General Formula 1 and a copolymerization component having the pigment adsorption portion, and a structure denoted by General Formula 2 described below, or a structure denoted by General Formula 3 described below;

(A¹-R⁴)ₗ—R³—(R⁵—P¹)ₘ General Formula 2

A¹-R⁵—P¹ General Formula 3

in General Formulas 2 and 3, R³ represents an (m+l)-valent organic linking group, R⁴ and R⁵ each independently represent a single bond or a divalent linking group, A¹ represents a pigment adsorption portion or a hydrogen atom, P¹ represents a structure having the partial structure denoted by General Formula 1, m represents 1 to 8, and 1 represents 1 to 10; and

in General Formula 2 and General Formula 3, A¹ represents a pigment adsorption portion or a hydrogen atom. In General Formula 2 described above, one A¹ may be identical to each other, or may be different from each other.

A¹ may have one pigment adsorption portion, or may have a plurality of pigment adsorption portions. In a case where A¹ has a plurality of pigment adsorption portions, the plurality of pigment adsorption portions may be identical to each other, or may be different from each other. Furthermore, A¹ does not independently represent the pigment adsorption portion, and a combination of A¹ and R⁴ in General Formula 2, a combination of A¹ and R³ in General Formula 2, or a combination of A¹ and R⁵ in General Formula 3 may be the pigment adsorption portion. For example, in a case where A¹ is a hydrogen atom, and R⁴ is a sulfur atom, an embodiment representing a —SH group in which a combination of A¹ and R⁴ is a pigment adsorption portion, or the like is able to be included.

It is preferable that A¹, for example, is a monovalent organic group formed by bonding the pigment adsorption portion to an organic linking group configured of 1 to 200 carbon atoms, 0 to 20 nitrogen atoms, 0 to 100 oxygen atoms, 1 to 400 hydrogen atoms, and 0 to 40 sulfur atoms. In a case where the pigment adsorption portion itself is able to configure the monovalent organic group, the pigment adsorption portion may be naturally an organic group represented by A¹.

In the pigment dispersion the present invention, the pigment adsorption portion described above preferably has at least one selected from an acidic group, a group having a basic nitrogen atom, a urea group, a urethane group, a group having a coordinating oxygen atom, a hydrocarbon group having greater than or equal to 4 carbon atoms, a heterocyclic residue, an amide group, an alkoxy silyl group, an epoxy group, an isocyanate group, a hydroxyl group, and a thiol group, more preferably has at least one selected from an acidic group, a group having a basic nitrogen atom, a urea group, a group having a coordinating oxygen atom, a heterocyclic residue, an amide group, an alkoxy silyl group, a hydroxyl group, and a thiol group, particularly preferably has at least one selected from an acidic group, a hydroxyl group, and a thiol group, and more particularly preferably has an acidic group, a hydroxyl group, and a thiol group.

Examples of the acidic group represented by the pigment adsorption portion include a carboxylic acid group, a sulfonic acid group, a monosulfuric acid ester group, a phosphoric acid group (a phosphono group or the like), a phosphonooxy group, a monophosphoric acid ester group, and a boric acid group, more preferably include a carboxylic acid group, a sulfonic acid group, a monosulfuric acid ester group, a phosphoric acid group, a phosphonooxy group, and a monophosphoric acid ester group, and particularly preferably include a carboxylic acid group, a sulfonic acid group, and a phosphoric acid group.

Examples of the group having the basic nitrogen atom represented by the pigment adsorption portion include an amino group (—NH₂), a substituted imino group (—NHR⁸, —NR⁹R¹⁰, here, R⁸, R⁹, and R¹⁰ each independently represent an alkyl group having 1 to 20 carbon atoms, an aryl group having greater than or equal to 6 carbon atoms, and an aralkyl group having greater than or equal to 7 carbon atoms), a guanidyl group, an amidinyl group, and the like.

Examples of the urea group represented by the pigment adsorption portion include —NR¹⁵CONR¹⁶R¹⁷ (here, R¹⁵, R¹⁶, and R¹⁷ each independently represent a hydrogen atom, or an alkyl group having 1 to 20 carbon atoms, an aryl group having greater than or equal to 6 carbon atoms, and an aralkyl group having greater than or equal to 7 carbon atoms), more preferably include —NR¹⁵CONHR¹⁷ (here, R¹⁵ and R¹⁷ each independently represent a hydrogen atom, or an alkyl group having 1 to 10 carbon atoms, an aryl group having greater than or equal to 6 carbon atoms, and an aralkyl group having greater than or equal to 7 carbon atoms), and particularly preferably include —NHCONHR¹⁷ (here, R¹⁷ represents a hydrogen atom, or an alkyl group having 1 to 10 carbon atoms, an aryl group having greater than or equal to 6 carbon atoms, and an aralkyl group having greater than or equal to 7 carbon atoms).

Examples of the urethane group represented by the pigment adsorption portion include —NHCOOR¹⁸, —NR¹⁹COOR²⁰, —OCONHR²¹, —OCONR²²R²³ (here, R¹⁸, R¹⁹, R²⁰, R²¹, R²², and R²³ each independently represent an alkyl group having 1 to 20 carbon atoms, an aryl group having greater than or equal to 6 carbon atoms, and an aralkyl group having greater than or equal to 7 carbon atoms), and the like, more preferably include —NHCOOR¹⁸, —OCONHR²¹ (here, R¹⁸ and R²¹ each independently represent an alkyl group having 1 to 20 carbon atoms, an aryl group having greater than or equal to 6 carbon atoms, and an aralkyl group having greater than or equal to 7 carbon atoms), and the like, and particularly preferably include —NHCOOR¹⁸ and —OCONHR²¹ (here, R¹⁸ and R²¹ each independently represent an alkyl group having 1 to 10 carbon atoms, an aryl group having greater than or equal to 6 carbon atoms, and an aralkyl group having greater than or equal to 7 carbon atoms), and the like.

Examples of the group having the coordinating oxygen atom represented by the pigment adsorption portion include an acetyl acetonate group, crown ether, and the like.

Examples of the hydrocarbon group having greater than or equal to 4 carbon atoms represented by the pigment adsorption portion include an alkyl group having greater than or equal to 4 carbon atoms, an aryl group having greater than or equal to 6 carbon atoms, an aralkyl group having greater than or equal to 7 carbon atoms, and the like, more preferably include an alkyl group having 4 to 20 carbon atoms, an aryl group having 6 to 20 carbon atoms, an aralkyl group having 7 to 20 carbon atoms, and the like, and particularly preferably include an alkyl group having 4 to 15 carbon atoms (for example, an octyl group, a dodecyl group, and the like), an aryl group having 6 to 15 carbon atoms (for example, a phenyl group, a naphthyl group, and the like), an aralkyl group having 7 to 15 carbon atoms (for example, a benzyl group, and the like), and the like.

Examples of the heterocyclic residue represented by the pigment adsorption portion include thiophene, furan, xanthene, pyrrole, pyrroline, pyrrolidine, dioxolane, pyrazole, pyrazoline, pyrazolidine, imidazole, oxazole, thiazole, oxadiazole, triazole, thiadiazole, pyran, pyridine, piperidine, dioxane, morpholine, pyridazine, pyrimidine, piperazine, triazine, trithiane, isoindoline, isoindolinone, benzimidazolone, benzothiazole, succinimide, phthalimide, naphthalimide, hydantoin, indole, quinoline, carbazole, acridine, acridone, anthraquinone, and the like.

Examples of the amide group represented by the pigment adsorption portion include —CONHR²⁴ (here, R²⁴ represents an alkyl group having 1 to 20 carbon atoms, an aryl group having greater than or equal to 6 carbon atoms, and an aralkyl group having greater than or equal to 7 carbon atoms), and the like.

Examples of the alkoxy silyl group represented by the pigment adsorption portion include a trimethoxy silyl group, a triethoxy silyl group, and the like.

An organic linking group formed of a single bond, or 1 to 100 carbon atoms, 0 to 10 nitrogen atoms, 0 to 50 oxygen atoms, 1 to 200 hydrogen atoms, and 0 to 20 sulfur atoms is preferable as the organic linking group to be bonded to the adsorption portion, and the organic linking group may be a non-substituent group or may further have a substituent group.

Specific examples of the organic linking group are able to include a group configured of a structural units described below or a combination of the structural units.

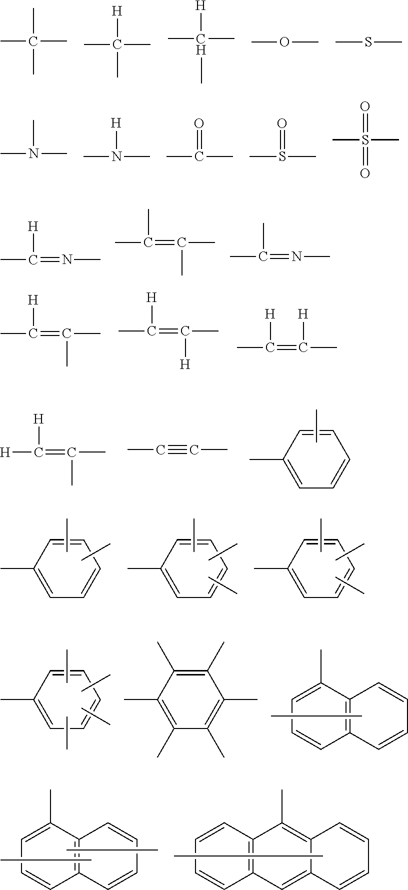

In a case where the organic linking group has a substituent group, examples of the substituent group include an alkyl group having 1 to 20 carbon atoms, such as a methyl group and an ethyl group, an aryl group having 6 to 16 carbon atoms, such as a phenyl group and a naphthyl group, an acyl oxy group having 1 to 6 carbon atoms, such as a hydroxyl group, an amino group, a carboxyl group, a sulfone amide group, an N-sulfonyl amide group, and an acetoxy group, an alkoxy group having 1 to 6 carbon atoms, such as a methoxy group and an ethoxy group, a halogen atom such as chlorine and bromine, an alkoxy carbonyl group having 2 to 7 carbon atoms, such as a methoxy carbonyl group, an ethoxy carbonyl group, and a cyclohexyl oxy carbonyl group, carbonate ester group such as a cyano group and a t-butyl carbonate, and the like.

Examples of other available embodiments of the organic group having the pigment adsorption portion are disclosed in [0016] to [0046] of JP2013-43962A, and [0016] to [0046] of JP2013-43962A are incorporated in the present invention.

In General Formula 2 and General Formula 3 described above, R⁴'s each independently represent a single bond or a divalent linking group. In General Formula 2 described above, one R⁴ may be identical to each other, or may be different from each other.

Examples of the divalent organic linking group include a group formed of 1 to 100 carbon atom, 0 to 10 nitrogen atoms, 0 to 50 oxygen atoms, 1 to 200 hydrogen atoms, and 0 to 20 sulfur atoms, and the divalent organic linking group may be a non-substituent group or may further have a substituent group.

Specific examples of the divalent organic linking group represented by R⁴ are able to include a group configured of a structural unit selected from a structural unit group G described below or a combination of the structural units.

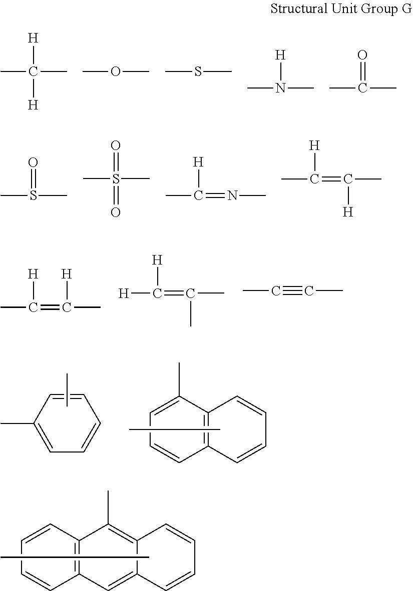

A single bond, or a divalent organic linking group formed of 1 to 50 carbon atoms, 0 to 8 nitrogen atoms, 0 to 25 oxygen atoms, 1 to 100 hydrogen atoms, and 0 to 10 sulfur atoms is preferable as R⁴, a single bond, or a divalent organic linking group formed of 1 to 30 carbon atoms, 0 to 6 nitrogen atoms, 0 to 15 oxygen atoms, 1 to 50 hydrogen atoms, and 0 to 7 sulfur atoms is more preferable, and a single bond, or a divalent organic linking group formed of 1 to 10 carbon atoms, 0 to 5 nitrogen atoms, 0 to 10 oxygen atoms, 1 to 30 hydrogen atoms, and 0 to 5 sulfur atoms is particularly preferable.

That is, preferred examples of the structure denoted by General Formula 2 include a structure denoted by General Formula 2′ described below.

(A¹-R^{4A}—S)ₗ—R³—(R⁵—P¹)ₘ General Formula 2′

In the formula, A¹, R⁴, R⁵, P¹, l, and m are respectively identical to those in General Formula 2, and preferred ranges are also identical to those of A¹, R⁴, R⁵, P¹, l, and m in General Formula 2. S represents a sulfur atom, and R^{4A} represents a single bond or a divalent organic linking group. n R^{4A}'s may be identical to each other, or may be different from each other. The same examples as those of the divalent organic linking group represented by R⁴ in General Formula 2 are used as the divalent organic linking group represented by R^{4A}, and a preferred embodiment is also identical to that of the divalent organic linking group represented by R⁴ in General Formula 2.

R^{4A} preferably represents a single bond, or a divalent organic linking group formed of “1 to 10 carbon atoms, 0 to 5 nitrogen atoms, 0 to 10 oxygen atoms, 1 to 30 hydrogen atoms, and 0 to 5 sulfur atoms” (the divalent organic linking group may have a substituent group, and examples of the substituent group include an alkyl group having 1 to 20 carbon atoms, such as a methyl group and an ethyl group, an aryl group having 6 to 16 carbon atoms, such as a phenyl group and a naphthyl group, an acyl oxy group having 1 to 6 carbon atoms, such as a hydroxyl group, an amino group, a carboxyl group, a sulfone amide group, an N-sulfonyl amide group, and an acetoxy group, an alkoxy group having 1 to 6 carbon atoms, such as a methoxy group and an ethoxy group, a halogen atom such as chlorine and bromine, an alkoxy carbonyl group having 2 to 7 carbon atoms such as a methoxy carbonyl group, an ethoxy carbonyl group, and a cyclohexyl oxy carbonyl group, a carbonate ester group such as a cyano group and a t-butyl carbonate, and the like), which is configured of a structural unit selected from the structural unit group G described above or a combination of the structural units.

In General Formula 2 and General Formula 3 described above, R³ represents a (m+1)-valent organic linking group. It is preferable that m+1 satisfies 3 to 10.

Examples of the (m+l)-valent organic linking group represented by R³ include a group formed of 1 to 100 carbon atoms, 0 to 10 nitrogen atoms, 0 to 50 oxygen atoms, 1 to 200 hydrogen atoms, and 0 to 20 sulfur atoms, and the (m+l)-valent organic linking group may be a non-substituent group, or may further have a substituent group.

Specific examples of the (m+l)-valent organic linking group are able to include a group configured of a structural units described below, or a combination of the structural units (may form a ring structure).

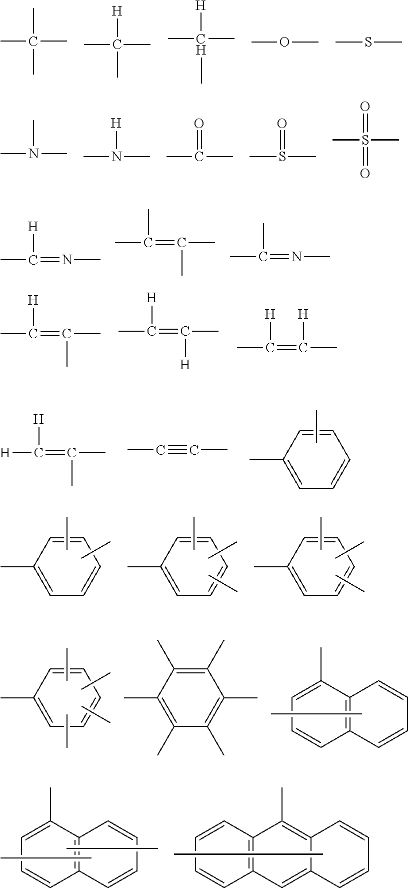

A group formed of 1 to 60 carbon atoms, 0 to 10 nitrogen atoms, 0 to 40 oxygen atoms, 1 to 120 hydrogen atoms, and 0 to 10 sulfur atoms is preferable as the (m+l)-valent organic linking group, a group formed of 1 to 50 carbon atoms, 0 to 10 nitrogen atoms, 0 to 30 oxygen atoms, 1 to 100 hydrogen atoms, and 0 to 7 sulfur atoms is more preferable, and a group formed of 1 to 40 carbon atoms, 0 to 8 nitrogen atoms, 0 to 20 oxygen atoms, 1 to 80 hydrogen atoms, and 0 to 5 sulfur atoms is particularly preferable.

In the above description, in a case where the (m+l)-valent organic linking group has a substituent group, example of the substituent group include an alkyl group having 1 to 20 carbon atoms, such as a methyl group and an ethyl group, an aryl group having 6 to 16 carbon atoms, such as a phenyl group and a naphthyl group, an acyl oxy group having 1 to 6 carbon atoms, such as a hydroxyl group, an amino group, a carboxyl group, a sulfone amide group, an N-sulfonyl amide group, and an acetoxy group, an alkoxy group having 1 to 6 carbon atoms, such as a methoxy group and an ethoxy group, a halogen atom such as chlorine and bromine, an alkoxy carbonyl group having 2 to 7 carbon atoms, such as a methoxy carbonyl group, an ethoxy carbonyl group, and a cyclohexyl oxy carbonyl group, a carbonate ester group such as a cyano group and a t-butyl carbonate, and the like.

Specific examples of the (m+l)-valent organic linking group represented by R³ are disclosed in [0060] to [0063] of JP2013-43962A, and [0060] to [0063] of JP2013-43962A are incorporated in the present invention. However, the present invention is not limited thereto.

In General Formula 2 and General Formula 3 described above, R⁵'s each independently represent a single bond or a divalent linking group. In General Formula 2 described above, m R⁵'s may be identical to each other, or may be different from each other.

Examples of the divalent linking group represented by R⁵ include the examples of the divalent linking group represented by R⁴. It is preferable that R⁵ is a single bond or —S—.

In General Formula 2 and General Formula 3 described above, P¹ represents a structure including a partial structure denoted by General Formula 1.

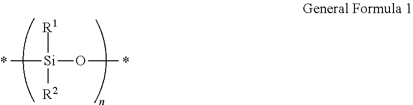

In General Formula 1, R¹ and R² each independently represent an alkyl group having 1 to 4 carbon atoms, an alkoxyl group having 1 to 2 carbon atoms, or a hydrogen atom, and n represents a natural number.

R¹ and R² each independently preferably represent an alkyl group having 1 to 4 carbon atoms, more preferably represent a methyl group or an ethyl group, and particularly preferably represent a methyl group.

n represents a natural number, is preferably 2 to 300, and is more preferably 10 to 200.

The structure having the partial structure denoted by General Formula 1 is able to be selected from various polymer skeletons according to the purpose or the like. m P¹'s may be identical to each other, or may be different from each other. P¹ has at least one constitutional unit. P¹ may have two or more constitutional units, and in this case, at least one constitutional unit is the partial structure denoted by General Formula 1.

P¹ has the partial structure denoted by General Formula 1. It is preferable that the partial structure denoted by General Formula 1 is a constitutional unit derived from a silicone-based monomer, and the silicone-based monomer may be a silicone-based macromer. Furthermore, herein, the “macromer (also referred to as a macro monomer)” is the general term of an oligomer having a polymerizable functional group (a degree of polymerization of approximately greater than or equal to 2 and less than or equal to 300) or a polymer, and has the properties of both of a polymer and a monomer. It is preferable that the constitutional unit is a constitutional unit derived from a silicone-based macromer having a weight-average molecular weight of 1,000 to 50,000 (more preferably 1,000 to 10,000, and even more preferably 1,000 to 5,000).

Further, it is preferable that the polymer is soluble in an organic solvent. In a case where the affinity with respect to the organic solvent is low, for example, affinity with respect to a dispersion medium weakens, and an adsorption layer which is sufficient for dispersion stabilization is not able to be ensured, in a case of being used as a dispersing agent.

The structure including the partial structure denoted by General Formula 1 is not particularly limited, and for example, a methyl-based straight silicone resin, an acrylic resin-modified silicone resin, a polyester resin-modified silicone resin, an epoxy resin-modified silicone resin, an alkyd resin-modified silicone resin, a rubber-based silicone resin, and the like are able to be used as the structure.

The methyl-based straight silicone resin and the acrylic resin-modified silicone resin are more preferable, and the methyl-based straight silicone resin is even more preferable.

Examples of the structure including the partial structure denoted by General Formula 1 are able to include X-22-174ASX, X-22-174BX, KF-2012, X-22-173BX, X-22-3710, and the like, which are manufactured by Shin-Etsu Chemical Co., Ltd.

In General Formula 2 and General Formula 3 described above, 1 represents 1 to 10, preferably represents 1 to 5, more preferably represents 1 to 4, and particularly preferably represents 1 to 3.

In General Formula 2 and General Formula 3 described above, m represents 1 to 8, preferably represents 2 to 8, more preferably represents 2 to 7, and particularly preferably represents 3 to 6.

The content of the partial structure denoted by General Formula 1 in the pigment dispersing agent is preferably greater than or equal to 50 mass %, is more preferably greater than or equal to 60 mass %, and is particularly preferably greater than or equal to 74 mass %.

A manufacturing method of the pigment dispersing agent having the copolymer which contains at least the copolymerization component having the partial structure denoted by General Formula 1 described above and the copolymerization component having the pigment adsorption portion, and the structure denoted by General Formula 2, or the structure denoted by General Formula 3 is not particularly limited.

For example, the pigment dispersing agent is able to be synthesized by a combination of compounds A to D described below, and for example, the pigment dispersing agent is able to be synthesized by any one scheme of Formula 1) to Formula 3) described below. In the compounds A to D, and Formula 1) to Formula 3), PGMEA is propylene glycol monomethyl ether acetate which is an example of an ester-based solvent, V-601 is dimethyl-2,2′-azobis(2-methyl propionate) which is an example of a polymerization initiator, l, m, and n are identical to l, m, and n in General Formulas 1 to 3, x is an integer of greater than or equal to 0, R, X, R′, and Y represent substituent groups shown in Table 2 and Table 3 described below.

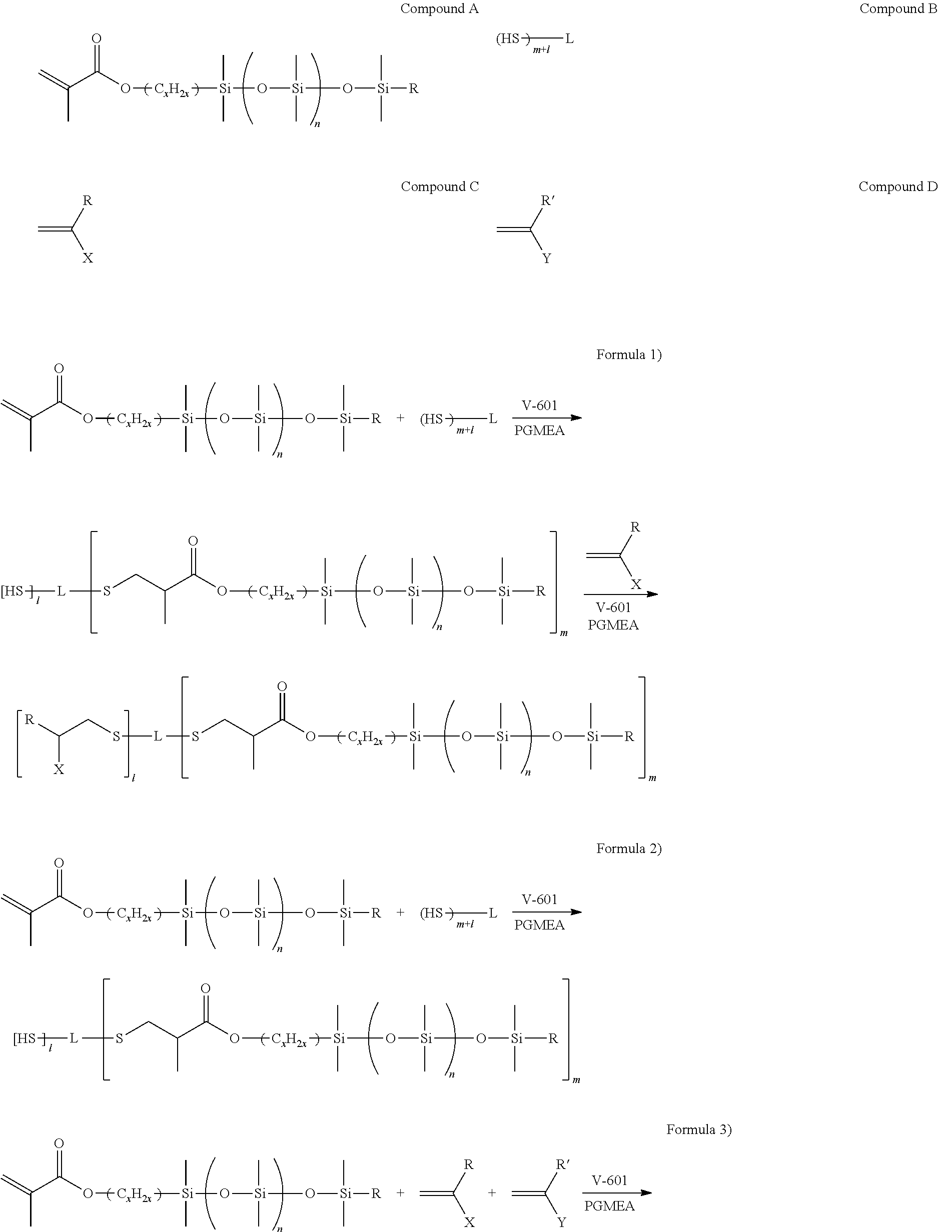

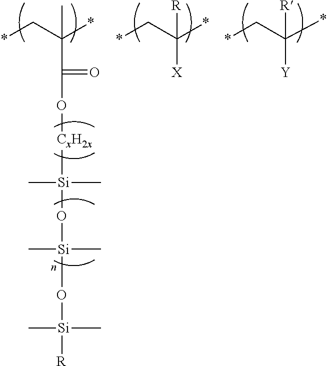

A preferred embodiment of the manufacturing method of the pigment dispersing agent described above is disclosed in [0110] to [0134] of JP2013-43962A, and [0110] to [0134] of JP2013-43962A are incorporated in the present invention. However, the present invention is not limited thereto.

The weight-average molecular weight of the pigment dispersing agent is preferably 1,000 to 5,000,000, is more preferably 2,000 to 3,000,000, and is particularly preferably 2,500 to 3,000,000. In a case where the molecular weight is greater than or equal to 1,000, film forming properties become excellent. The weight-average molecular weight, for example, is able to be measured by gel permeation chromatography (GPC). Specifically, the weight-average molecular weight is able to be measured in the following conditions.
Column: GPC Column TSKgelSuper HZM-H (manufactured by TOSOH CORPORATION)
Solvent: Tetrahydrofuran
Standard Substance: Monodispersed Polystyrene

(White Pigment)

A white pigment disclosed in paragraph 0015 or paragraph 0114 of JP2005-7765A is able to be used as the white pigment.

Specifically, titanium oxide, zinc oxide, lithophone, light calcium carbonate, white carbon, aluminum oxide, aluminum hydroxide, and barium sulfate are preferable as the white pigment, titanium oxide and zinc oxide are more preferable, and in the present invention, it is particularly preferable that the white pigment is titanium oxide, and among them, rutile type titanium oxide or anatase type titanium oxide is more particularly preferable, and the rutile type titanium oxide is even more particularly preferable.

The surface of titanium oxide is able to be subjected to a silica treatment, an alumina treatment, a titania treatment, a zirconia treatment, an organic matter treatment, and a combination thereof.

Accordingly, it is possible to suppress the catalystic activity of the titanium oxide, and it is possible to improve heat resistance, matting properties, and the like.

The alumina treatment, the zirconia treatment, and the silica treatment are preferable as a surface treatment with respect to the surface of the titanium oxide, and a combined treatment of alumina/zirconia or a combined treatment of alumina/silica is particularly preferable, from the viewpoint of suppressing the b value of the coated film of the pigment dispersion of the present invention after being subjected to a high temperature treatment.

The pigment dispersion of the present invention is preferably for forming a white decorative material, and is more preferably for forming a white decorative material which is used in a touch panel.

The content ratio of the white pigment with respect to the pigment dispersion is preferably 20 mass % to 90 mass %, is more preferably 30 mass % to 80 mass %, and is even more preferably 40 mass % to 75 mass %.

In addition, the weight ratio of the pigment dispersing agent with respect to the white pigment is preferably 0.2% to 25%, is more preferably 0.5% to 20%, and is even more preferably 1% to 15%.

In the present invention, the pigment dispersion which is suitable for the material of a white decorative material described below or a white colored layer described below is provided. The pigment dispersion of the present invention contains at least the white pigment, a pigment dispersing agent described above, and any one of a hydrocarbon-based solvent, a ketone-based solvent, an ester-based solvent, and an alcohol-based solvent. An additional binder resin, a coating auxiliary, a curing catalyst, an antioxidant, an additional solvent, or other additives are added to the pigment dispersion of the present invention, and thus, are able to be used as the material of a white colored layer described below.

A method of preparing the pigment dispersion of the present invention is not particularly limited, but it is preferable to use only the white pigment, the pigment dispersing agent, and the solvent (and selectively a small amount of dispersion binder) at the time of performing pigment dispersion. In particular, it is preferable that additives such as an additional binder described below or a condensation catalyst described below are not added as the material of the pigment dispersion at the time of performing the pigment dispersion from the viewpoint of not obstructing a dispersion step.

In a case where the pigment dispersion of the present invention is used as the material of the white colored layer (more specifically, a coating liquid), it is preferable that the additive such as the additional binder described below or the condensation catalyst described below is added to the pigment dispersion of the present invention after preparing the pigment dispersion of the present invention, and thus, the material of the white colored layer is prepared. Accordingly, a preferred content ratio of the white pigment in the pigment dispersion of the present invention may be different from a preferred content ratio of the white pigment in the white colored layer described below.

Hereinafter, first, a preferred embodiment of the pigment dispersion of the present invention in a stage where the pigment dispersion of the present invention is prepared will be described, and then, a preferred embodiment in a case of using the pigment dispersion of the present invention as the material of the white colored layer (more specifically, the coating liquid) will be described.

By applying miscibility with respect to various additives to be added at the time of being used as the material of the white colored layer to the pigment dispersion of the present invention, it is possible to obtain a white coated film having glossiness, and thus, in the pigment dispersion of the present invention, any one of a hydrocarbon-based solvent, a ketone-based solvent, an ester-based solvent, and an alcohol-based solvent is used as the solvent thereof.

Xylene, toluene, benzene, ethyl benzene, hexane, and the like are preferable as the hydrocarbon-based solvent.

Methyl ethyl ketone, methyl isobutyl ketone, cyclohexanone, acetone, diethyl ketone, and the like are preferable as the ketone-based solvent.

Propylene glycol monomethyl ether acetate, ethyl acetate, butyl acetate, ethyl cellosolve acetate, butyl cellosolve acetate, and the like are preferable as the ester-based solvent.

Propylene glycol monomethyl ether, ethyl cellosolve, butyl cellosolve, normal propyl alcohol, butanol, and the like are preferable as the alcohol-based solvent.

Among them, the hydrocarbon-based solvent, the ester-based solvent, and the ketone-based solvent are preferable, and the xylene, the methyl ethyl ketone, the methyl isobutyl ketone, the propylene glycol monomethyl ether acetate, and the ethyl acetate are particularly preferable.

The content of any one of the hydrocarbon-based solvent, the ketone-based solvent, the ester-based solvent, and the alcohol-based solvent to the pigment dispersion of the present invention (the total of solid contents and the solvent), is preferably 8 mass % to 90 mass %, is more preferably 10 mass % to 70 mass %, and is particularly preferably 12 mass % to 50 mass %.

A dispersing machine which is used at the time of dispersing the white pigment is not particularly limited, and examples of the dispersing machine include a known dispersing machine disclosed in Page 438 of “Dictionary of Pigments”, the first edition, written by Kunizou ASAKURA and published by Asakura Publishing Co., Ltd., 2000, such as a kneader, a roll mill, an atto rider, a super mill, a dissolver, a homomixer, a sand mill, and a bead mill. Further, pulverizing using a friction force by mechanical grinding disclosed in Page 310 of the literature described above may be performed.

In the white pigment which is used in the present invention, the average particle diameter of primary particles is preferably 0.16 μm to 0.3 μm, and is more preferably 0.18 μm to 0.27 μm, from the viewpoint of dispersion stability and hiding power. Further, the average particle diameter of the primary particles is particularly preferably 0.19 μm to 0.25 μm. In a case where the average particle diameter of the primary particles is greater than or equal to 0.16 μm, the hiding power increases, the base of a light shielding layer is rarely observed, and an increase in viscosity rarely occurs. In contrast, in a case where the average particle diameter of the primary particles is less than or equal to 0.3 μm, the whiteness is sufficiently high, the hiding power is high at the same time, and the surface conditions at the time of performing coating are excellent.

Furthermore, here, the “average particle diameter of the primary particles” indicates a diameter at the time of setting an electron microscope photographic image of the particles as a circle having the same area, and the “number average particle diameter” indicates the average value of 100 particle diameters obtained from a plurality of particles described above.

In order to disperse the white pigment, the pigment dispersing agent described above having the partial structure denoted by General Formula 1 described above and the pigment adsorption portion in the same molecule is used. The amount of pigment dispersing agent described above is required to be minimized from the viewpoint of thermal coloration after performing baking.

In contrast, in a case where the pigment dispersion sufficiently contains the pigment dispersing agent described above, the stability of the dispersion is improved, and the precipitation and the aggregation of white pigment particles are rarely observed.

In the precipitation and the aggregation of the white pigment particles, it is effective that a dispersion binder is added in addition to the pigment dispersing agent described above at the time of performing dispersion, and codispersion is performed. It is preferable that a silicone resin and a silicone oligomer are added as the dispersion binder from the viewpoint of the thermal coloration. That is, the pigment dispersion of the present invention may further contain a silicone resin. Such a silicone resin is not particularly limited, and a methyl silicone resin and a dimethyl silicone resin are preferable. A commercially available silicone resin may be used as the silicone resin, and for example, KR251, KR255, KR300, KR311, X-40-9246, and the like which are manufactured by Shin-Etsu Chemical Co., Ltd. are able to be used.

The content of the dispersion binder to the solid content in the pigment dispersion of the present invention is preferably 0.1 mass % to 30 mass %, is more preferably 0.2 mass % to 20 mass %, and is particularly preferably 0.5 mass % to 10 mass %.

As described above, an additional binder resin, a coating auxiliary, a curing catalyst, an antioxidant, an additional solvent, or other additives may be added at the time of using the pigment dispersion of the present invention as the material of the white colored layer, as necessary. Hereinafter, the details thereof will be described.

(Additional Binder Resin)

It is preferable to add the additional binder resin at the time of using the pigment dispersion of the present invention as the material of the white colored layer. The additional binder resin is not particularly limited, but a silicone resin is preferable from the viewpoint of the heat resistance. A known silicone resin is able to be used as the silicone resin, and a silicone resin such as a methyl-based straight silicone resin, a methyl phenyl-based straight silicone resin, an acrylic resin-modified silicone resin, a polyester resin-modified silicone resin, an epoxy resin-modified silicone resin, an alkyd resin, a modified silicone resin, and a rubber-based silicone resin is able to be used. The methyl-based straight silicone resin, the methyl phenyl-based straight silicone resin, and the acrylic resin-modified silicone resin are more preferable, and the methyl-based straight silicone resin and the methyl phenyl-based straight silicone resin are particularly preferable.

Only one type of additional binder resin may be used, or two or more types thereof may be used by being mixed. By mixing the additional binder resins at an arbitrary ratio, it is possible to control film physical properties. The additional binder resin may be identical to the dispersion binder, or may be different from the dispersion binder.

A binder resin which is dissolved in an organic solvent or the like may be used as the additional binder resin, and for example, a binder resin which is dissolved in a xylene solution or a toluene solution is able to be used.

(Curing Catalyst)

In a case where the silicone resin is used in any one or a plurality of the pigment dispersing agent, the dispersion binder, and the additional binder resin, a condensation reaction curing catalyst (also referred to as a polymerization catalyst) may be used in order to form a cured film by accelerating a crosslinking reaction. The condensation reaction curing catalyst is preferably a condensation catalyst containing a metal salt, and is more preferably a condensation catalyst containing an organic acid metal salt.

A known condensation catalyst of the related art is preferably used as a condensation catalyst (b) formed of the metal salt (excluding an alkaline metal salt and an alkaline earth metal salt), and more preferably, the organic acid metal salt (excluding an alkaline metal salt and an alkaline earth metal salt). That is, examples of the component (b) are able to include an aluminum salt, a tin salt, a lead salt, or a transition metal salt of an organic acid, and the organic acid and the metal ions may form a complex salt represented by a chelate structure. A condensation catalyst containing one type or two or more types of metals selected from aluminum, titanium, iron, cobalt, nickel, zinc, zirconium, cobalt, palladium, tin, mercury, or lead is particularly preferable as the component (b), and an organic acid zirconium salt, an organic acid tin salt, and an organic acid aluminum salt are most preferably used.

Specific examples of the condensation catalyst which is the component (b) include an organic acid tin salt such as dibutyl tin diacetate, dibutyl tin dioctate, dibutyl tin dilaurate, dibutyl tin dimalate, dioctyl tin dilaurate, dioctyl tin dimalate, and tin octylate; an organic acid titanium salt such as tetra(i-propyl) titanate, tetra(n-butyl) titanate, dibutoxy bis(acetyl acetonate) titanium, isopropyl triisostearoyl titanate, isopropyl tris(dioctyl pyrophosphate) titanate, and bis(dioctyl pyrophosphate) oxy acetate titanate; an organic acid zirconium salt such as tetrabutyl zirconate, tetrakis(acetyl acetonate) zirconium, tetraisobutyl zirconate, butoxy tris(acetyl acetonate) zirconium, zirconium naphthenate, and zirconium octylate; an organic acid aluminum salt such as tris(ethyl acetoacetate) aluminum and tris(acetyl acetonate) aluminum; and an organic acid metal salt such as zinc naphthenate, zinc formate, zinc acetyl acetonate, iron acetyl acetonate, cobalt naphthenate, and cobalt octylate. In addition, CAT-AC, D-15, D, and D-25 (which are manufactured by Shin-Etsu Chemical Co., Ltd.) may be used as a commercially available product.

The use amount of the catalyst described above may be the amount of catalyst, and the metal is able to be used in the amount of 0.1 mass % to 20 mass % with respect to the pigment dispersing agent, the dispersion binder, and the additional binder resin and is able to be arbitrarily selected according to the curing conditions.

(Other Materials)

Examples of other materials which are able to be used in the white colored layer are able to include materials which are able to be used in a white colored layer of a transfer material described below, and a preferred range of the other material is also identical to a preferred range of the material which is able to be used in the white colored layer of the transfer material.

The component other than the materials described above which may be contained in the white colored layer is not particularly limited, and a known pigment dispersion stabilizer, a known coating auxiliary, a known antioxidant, and the like are able to be used, and it is desirable that the tint of the white colored layer is not changed, or is changed to a desired tint.

Furthermore, it is preferable that the content ratio of the white pigment with respect to the solid content of the white colored layer is 20 mass % to 75 mass %. In a case where the content ratio of the white pigment is set to be in the range, it is possible to form a decorative material in which brightness and whiteness (a small b value) after performing heating at the same degree as that at the time of depositing a conductive layer by sputtering are set to be in an excellent range, and other properties to be required are simultaneously satisfied. The content ratio of the white pigment with respect to the solid content of the white colored layer is more preferably 25 mass % to 60 mass %, and is even more preferably 30 mass % to 50 mass %.

Herein, the total solid content indicates the total mass of a non-volatile component in which a solvent or the like is removed from the white colored layer.

It is preferable that the content ratio of the component other than the white pigment with respect to the solid content of the white colored layer is greater than or equal to 30 mass %. In a case where the content ratio of the component other than the white pigment is in the range, a preferred influence is able to be provided to the tint of the white colored layer of the present invention. The content ratio of the component other than the white pigment in the white colored layer is more preferably 30 mass % to 80 mass %, is even more preferably 35 mass % to 70 mass %, and is particularly preferably 40 mass % to 65 mass %.

In addition, the ratio of the additional binder resin (preferably, the silicone resin) with respect to the component other than the white pigment in the white colored layer is preferably greater than or equal to 80 mass %, and is more preferably greater than or equal to 90 mass %, from the viewpoint of obtaining the effect of the present invention.

[White Decorative Material]

It is preferable that the pigment dispersion of the present invention is used in a white decorative material of the present invention, and the white decorative material of the present invention is formed by heating a coated film which is prepared on the basis of the pigment dispersion of the present invention. In addition, the white decorative material of the present invention may be formed by forming the coated film which is prepared on the basis of the pigment dispersion of the present invention as a white colored layer, and then, by heating the white colored layer.

[Substrate Attached with White Decorative Material]

A substrate attached with a white decorative material of the present invention includes the white decorative material of the present invention, and a substrate. The substrate attached with a white decorative material of the present invention is a substrate attached with a white decorative material including a substrate, a white decorative material formed by heating a white colored layer, a light shielding layer, and a conductive layer in this order, the substrate attached with a white decorative material includes a light transmitting region transmitting light in a thickness direction, a decorative material configured of the white decorative material which is formed by heating the white colored layer and the light shielding layer is laminated on the substrate to surround the light transmitting region, and it is preferable that a tilt portion formed such that the thickness of the decorative material becomes thin towards the inside of the light transmitting region is provided on the inner edge of the decorative material, and it is more preferable that a tilt angle between the surface of the tilt portion and the surface of the substrate is 10 degrees to 60 degrees. The decorative material includes the tilt portion, and the tilt angle between the surface of the tilt portion and the surface of the substrate is 10 degrees to 60 degrees, and thus, a level difference in a film thicknesses between the decorative material and a portion of the substrate on which the decorative material is not formed is relaxed, and a problem such as the disconnection of the conductive layer on the light shielding layer rarely occurs.

Hereinafter, a preferred embodiment of the substrate attached with a white decorative material of the present invention will be described.

<Properties of Substrate Attached with White Decorative Material>

The “decorative material” in the substrate attached with a white decorative material of the present invention indicates a laminate of the white decorative material formed by heating the white colored layer and the light shielding layer. In the substrate attached with a white decorative material of the present invention, a light leakage or the like is able to be suppressed by a configuration including the white decorative material formed by heating the white colored layer and the light shielding layer in this order from the substrate (a film or glass) side.

In the substrate attached with a white decorative material of the present invention, the optical concentration of the substrate attached with a white decorative material is preferably 3.5 to 6.0, is more preferably 4.0 to 5.5, and is particularly preferably 4.5 to 5.0.

In the substrate attached with a white decorative material of the present invention, an L value of the tint of the substrate with a white decorative material on the substrate side is preferably 85 to 95, is more preferably 86 to 95, is particularly preferably 87 to 95, and is more particularly preferably 88 to 95, in an SCI index. Further, in the substrate attached with a white decorative material of the present invention, it is preferable that the L value of the substrate attached with a white decorative material on the substrate side after being subjected to a high temperature treatment at 280° C. for 30 minutes is in the range described above in the SCI index from the viewpoint of improving the tint after deposition of the conductive layer on the light shielding layer by sputtering.

In the substrate attached with a white decorative material of the present invention, a b value of the tint of the substrate attached with a white decorative material on the substrate side is preferably 1.5 to 4.0, is more preferably 1.5 to 3.8, is particularly preferably 1.5 to 3.6, and is more particularly preferably 1.5 to 3.4, in the SCI index. Further, in the substrate attached with a white decorative material of the present invention, it is preferable that the b value of the substrate attached with a decorative material on the substrate side after being subjected to a high temperature treatment at 280° C. for 30 minutes is in the range described above in the SCI index from the viewpoint of improving the tint after the deposition of the conductive layer on the light shielding layer by sputtering.

The decorative material of the present invention is a frame-like pattern around the light transmitting region (a display region) formed on a non-contact side of a front plate of the touch panel, and is formed in order to prevent routing wiring or the like from being observed or to perform decoration.

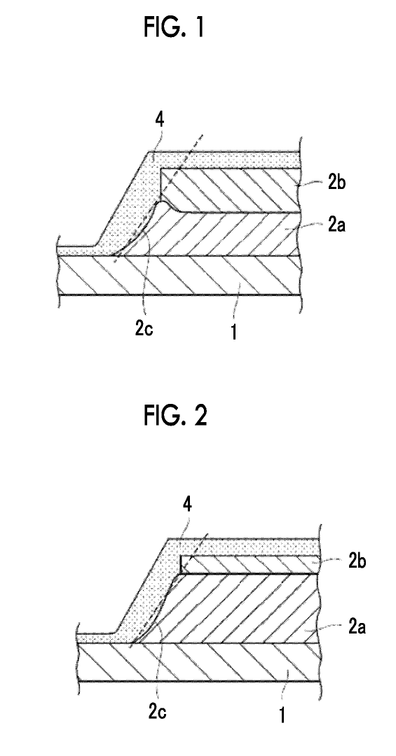

As illustrated in examples of FIG. 1 to FIG. 3, it is preferable that a tilt portion 2c formed such that the thickness of the decorative material becomes thin towards the inside of the light transmitting region is provided on the inner edge of a decorative material which is a laminate of a white decorative material 2a formed by heating a white colored layer and a light shielding layer 2b and is disposed on a substrate 1. It is preferable that a conductive layer 6 is formed on the decorative material, and extends to the substrate 1 along the tilt portion 2c of the decorative material.

By disposing the tilt portion, the level difference in the film thicknesses between the decorative material and the portion of the substrate on which the decorative material is not formed is relaxed, and the problem such as the disconnection of the conductive layer rarely occurs.

A formation method of the tilt portion is not particularly limited, and examples of the formation method include a method of forming the tilt portion by contracting the light shielding layer by heating, a method of forming the tilt portion by melting a white colored layer by heating, and the like, and the method of forming the tilt portion by contacting the light shielding layer by heating is preferable. By contracting a light shielding portion by heating, the white colored layer on the light shielding portion side is also contracted following the light shielding layer, and the white colored layer on the substrate side is not contracted following the light shielding layer, and thus, the tilt portion is able to be formed. The formation of the tilt portion by contracting the light shielding layer by heating will be described below.

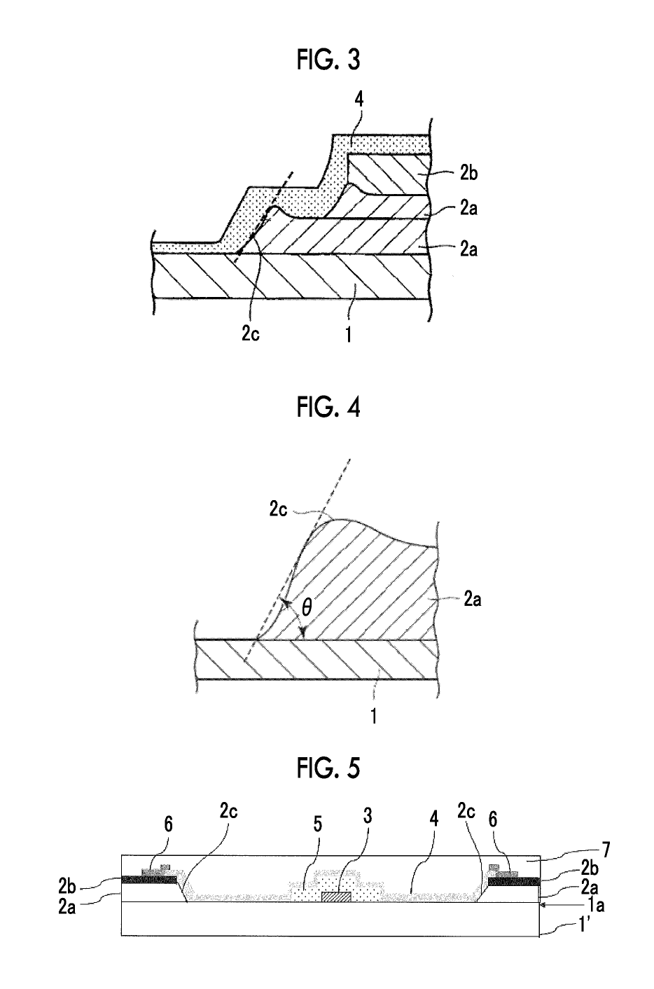

The shape of the tilt portion 2c in the decorative material is not particularly limited, and for example, the tilt portion 2c may have a shape including a protruding projection as illustrated in the examples of FIG. 1 and FIG. 3, or may have a shape connected with a smooth curve as illustrated in the example of FIG. 2. In addition, as illustrated in FIG. 1 to FIG. 3, in the tilt portion 2c, the thickness of the white decorative material 2a formed by heating the white colored layer may be thin towards the inside of the light transmitting region, and the thickness of the light shielding layer 2b may be thin towards the inside of the light transmitting region, as with the white decorative material 2a formed by heating the white colored layer. As illustrated in the example of FIG. 3, the decorative material may be an embodiment in which two or more layers of the white decorative material 2a formed by heating the white colored layer are laminated.

A tilt angle θ between the surface of the tilt portion and the surface of the substrate of the present invention illustrated in FIG. 4 is 10 degrees to 60 degrees, and is more preferably 15 degrees to 55 degrees. In a case where the tilt angle θ is greater than or equal to 10 degrees, a portion decreases in which the light shielding layer is not provided on the white decorative material formed by heating the white colored layer, an abnormal appearance, that is, a region having a low optical concentration decreases, and thus, a case where the light leakage in a display device or a circuit frame is observed is reduced. In contrast, in a case where the tilt angle θ is less than or equal to 60 degrees, the occurrence of the problem such as the disconnection of the conductive layer decreases.

As illustrated by a dotted line of FIGS. 1 to 4, the tilt angle θ is a tilt angle between a plane which is obtained by approximating the surface of the tilt portion to a plane and the surface of the substrate. The tilt angle θ is able to be obtained by cutting the substrate, and by measuring an angle tilting to the substrate from a sectional direction using an optical microscope.

In a case where the tilt portion is formed by contracting the light shielding layer by heating, it is possible to form a tilt portion having a desired tilt angle by changing the type and/or the composition of a resin configuring the white colored layer and/or the light shielding layer.

In the present invention, it is preferable that the tilt angle θ is set such that a difference between the width of the white decorative material formed by heating the white colored layer on the substrate side and the width of the light shielding layer is less than or equal to 200 μm. According to such a configuration, it is possible to solve the problem such as the abnormal appearance and the disconnection of the conductive layer.

The difference (an edge difference) between the width of the white decorative material formed by heating the white colored layer on the substrate side and the width of the light shielding layer is preferably less than or equal to 200 μm, is preferably 5 μm to 100 μm, and is more preferably 10 μm to 90 μm.

The width of the white decorative material formed by heating the white colored layer on the substrate side indicates the width of the white decorative material formed by heating the white colored layer on a side in contact with the substrate in the white decorative material formed by heating the white colored layer.

<Substrate>

Various substrates are able to be used as the substrate which is used in the substrate attached with a white decorative material of the present invention, and it is preferable that the substrate is a film substrate, and it is more preferable that a substrate which is not optically distorted or a substrate having high transparency is used as the substrate. In the substrate attached with a white decorative material of the present invention, it is preferable that the total light transmittance of the substrate is greater than or equal to 80%.

Examples of a specific material in a case where the substrate is a film substrate are able to include polyethylene terephthalate (PET), polyethylene naphthalate, polycarbonate (PC), triacetyl cellulose (TAC), and a cycloolefin polymer (COP).

The substrate may be glass or the like.

In the substrate attached with a white decorative material of the present invention, it is preferable that the substrate is selected from glass, TAC, PET, PC, COP, or a silicone resin (herein, a silicone resin or polyorganosiloxane is not limited to the narrow sense denoted by a structural unit formula of R₂SiO, but includes a silsesquioxane compound denoted by a structural unit formula of RSiO_{1.5}), and it is preferable that the substrate is selected from glass, a cycloolefin polymer, or a silicone resin.

It is preferable that the silicone resin contains cage type polyorganosiloxane as a main component, and it is more preferable that the silicone resin contains a cage type silsesquioxane as a main component. Furthermore, a main component of a composition or a layer indicates a component which is contained in the composition or the layer in the amount of greater than or equal to 50 mass %. A silicone resin disclosed in JP4142385B, JP4409397B, JP5078269B, JP4920513B, JP4964748B, JP5036060B, and each publication of JP2010-96848A, JP2011-194647A, JP2012-183818A, JP2012-184371A, and JP2012-218322A is able to be used as the silicone resin or a substrate containing the silicone resin, and the contents thereof are incorporated in the present invention.

In addition, various functions may be added to the surface of the substrate. Specifically, examples of a functional layer are able to include an antireflection layer, an antiglare layer, a retardation layer, a view angle enhancement layer, a scratch resistance layer, a self-restoring layer, an antistatic layer, an antifouling layer, an antielectromagnetic wave layer, and a conductive layer.

In the substrate attached with a white decorative material of the present invention, it is preferable that the substrate includes the conductive layer on the surface of the substrate. A conductive layer disclosed in JP2009-505358A is able to be preferably used as the conductive layer.

It is preferable that the substrate further includes at least one of a scratch resistance layer or an antiglare layer.

In the substrate attached with a white decorative material of the present invention, the film thickness of the substrate is preferably 35 μm to 200 μm, is more preferably 40 μm to 150 μm, and is particularly preferably 40 μm to 100 μm.

In addition, in order to increase the adhesiveness of a colored layer by lamination in a transfer step, it is possible to perform a surface treatment with respect to the non-contact surface of the substrate (a front plate) in advance. It is preferable that a surface treatment using a silane compound (a silane coupling treatment) is performed as the surface treatment. A silane coupling agent having a functional group which interacts with a photosensitive resin is preferable as a silane coupling agent. For example, an aqueous solution of a silane coupling liquid (N-β(aminoethyl)γ-aminopropyl trimethoxy silane of 0.3 mass %, Product Name: KBM603, manufactured by Shin-Etsu Chemical Co., Ltd.) is sprayed by a shower for 20 seconds, and thus, pure water shower washing is performed. After that, a reaction is performed by heating. A heating bath may be used, and the reaction is able to be accelerated by preheating the substrate in a laminator.

<White Colored Layer and White Decorative Material>

In the substrate attached with a white decorative material of the present invention, it is preferable that the white decorative material formed by heating the white colored layer is provided between the substrate and the light shielding layer.

(Thickness of White Decorative Material Formed by Heating White Colored Layer)

In the substrate attached with a white decorative material of the present invention, it is preferable that the film thickness of the white decorative material formed by heating the white colored layer is 10 μm to 40 μm, from the viewpoint of increasing the hiding power of the white decorative material formed by heating the white colored layer.

The thickness of the white decorative material formed by heating the white colored layer is more preferably 15 μm to 40 μm, and is particularly preferably 20 μm to 38 μm.

(OD of White Decorative Material Formed by Heating White Colored Layer)

The optical concentration (also referred to as OD) of the white decorative material formed by heating the white colored layer is preferably greater than or equal to 0.5, and is particularly preferably greater than or equal to 1.0, from the viewpoint of increasing the hiding power of the white decorative material formed by heating the white colored layer.

<Light Shielding Layer>

It is preferable that the substrate attached with a white decorative material of the present invention includes the light shielding layer on the surface of the white decorative material formed by heating the white colored layer on a side opposite to the substrate. A resin for forming the light shielding layer is not particularly limited, but a thermally crosslinking resin is preferable as the resin.

Examples of the thermally crosslinking resin include a resin having a siloxane bond in a main chain, an epoxy resin, a melamine resin, and the like, and among them, the resin having a siloxane bond in a main chain is preferable. In addition, it is preferable that the light shielding layer contains a pigment.

(Silicone Resin)

It is preferable that the light shielding layer contains a silicone resin, and in particular, a methyl silicone resin is preferable as the resin. Here, the substrate attached with a white decorative material of the present invention may contain other binder resins in the light shielding layer unless contrary to the gist of the present invention.

The silicone resin and the component other than the pigment which are able to be used in the light shielding layer are respectively identical to those which are able to be used in the white decorative material formed by heating the white colored layer.

The ratio of the silicone resin with respect to the component other than the pigment contained in the light shielding layer is preferably greater than or equal to 60 mass %, and is more preferably greater than or equal to 70 mass %, from the viewpoint of obtaining the effect of the present invention.

Further, in the substrate attached with a white decorative material of the present invention, it is preferable that the ratio of the silicone resin with respect to the component other than the pigment contained in the white decorative material formed by heating the white colored layer is greater than or equal to 90 mass %, and the ratio of the silicone resin with respect to the component other than the pigment contained in the light shielding layer is greater than or equal to 70 mass %. In this case, a more preferred range is identical to a more particularly preferred range and an even more particularly preferred range of the white decorative material formed by heating the white colored layer or the light shielding layer.

(Color Material for Light Shielding Layer)

A pigment is preferable as a color material for a light shielding layer, and a black pigment is more preferable. Examples of the black pigment include carbon black, titanium black, titanium carbon, iron oxide, titanium oxide, black lead, and the like, and in the substrate attached with a white decorative material of the present invention, the light shielding layer preferably contains at least one of titanium oxide or carbon black, and more preferably contains carbon black.

(Other Materials)

Examples of other materials which are able to be used in the light shielding layer are able to include the materials which are able to be used in the colored layer of the film transfer material described below, and a preferred range of the other material is also identical to a preferred range of the material which is able to be used in the colored layer of the film transfer material.

(Thickness of Light Shielding Layer)

In the substrate attached with a white decorative material of the present invention, it is preferable that the film thickness of the light shielding layer is 1.0 μm to 5.0 μm from the viewpoint of increasing the hiding power of the light shielding layer.

The thickness of the light shielding layer is more preferably 1.0 μm to 4.0 μm, and is particularly preferably 1.5 μm to 3.0 μm.

(Optical Concentration of Light Shielding Layer)

The optical concentration (OD) of the light shielding layer is preferably greater than or equal to 3.5, and is particularly preferably greater than or equal to 4.0, from the viewpoint of increasing the hiding power of the light shielding layer.

(Surface Resistance of Light Shielding Layer)

In the substrate attached with a white decorative material of the present invention, the surface resistance of the light shielding layer is preferably greater than or equal to 1.0×10¹⁰Ω/, is more preferably greater than or equal to 1.0×10¹¹Ω/, is particularly preferably greater than or equal to 1.0×10¹²Ω/, and is more particularly preferably greater than or equal to 1.0×10¹³Ω/. Furthermore, Ω/ is Ω per square.

<Conductive Layer>

The substrate attached with a white decorative material of the present invention further includes the conductive layer on the light shielding layer.

A conductive layer disclosed in JP2009-505358A is able to be preferably used as the conductive layer. In addition, the configuration or the shape of the conductive layer will be described in the following description of a first transparent electrode pattern and a second electrode pattern, and other conductive elements in the description of the touch panel of the present invention.

In the substrate attached with a white decorative material of the present invention, it is preferable that the conductive layer contains indium (including an indium-containing compound such as ITO or an indium alloy).

In the substrate attached with a white decorative material of the present invention, the b value of the white decorative material formed by heating the white colored layer after being subjected to a high temperature treatment is small, and thus, even in a case where the conductive layer is deposited by sputtering, it is possible to decrease the b value of the white decorative material formed by heating the white colored layer of the substrate attached with a white decorative material to be obtained.

<Manufacturing Method of Substrate Attached with White Decorative Material>

A manufacturing method of the substrate attached with a white decorative material of the present invention is not particularly limited, but it is preferable that the white colored layer and the light shielding layer are respectively prepared by a method selected from film transfer, thermal transfer printing, screen printing, and ink jet printing, and the film transfer is particularly preferable.

Specifically, the manufacturing method of the substrate attached with a white decorative material includes a step of laminating a white colored layer and a light shielding layer on a substrate in this order, and the white colored layer and the light shielding layer are able to be respectively prepared by a method selected from a method of transferring at least one of a white colored layer or a light shielding layer onto a temporary support from a film transfer material including at least one of the white colored layer or the light shielding layer, and then, removing the temporary support, thermal transfer printing of heating a temporary support side of a film transfer material including at least one of a white colored layer or a light shielding layer on a temporary support, and transferring at least one of a white colored layer or a light shielding layer from the temporary support, screen printing of a composition for forming a white colored layer or a composition for forming a light shielding layer, and ink jet printing of a composition for forming a white colored layer or a composition for forming a light shielding layer. In addition, the decorative material is in the shape of a frame which surrounds the light transmitting region on the substrate, and the manufacturing method includes a step of forming the tilt portion on the inner edge of the decorative material such that the thickness of the decorative material becomes thin towards the inside of light transmitting region.

The white colored layer and the light shielding layer may be formed by a combined method of a plurality of film transfer, thermal transfer printing, screen printing, and ink jet printing.

Further, in the manufacturing method of the substrate attached with a white decorative material, it is preferable that the white colored layer and the light shielding layer are formed by transferring a light shielding layer and a white colored layer onto a substrate from a film transfer material including at least a temporary support, the light shielding layer, and the white colored layer in this order, and then, by removing the temporary support, or by transferring a white colored layer onto a substrate from a film transfer material including a temporary support and the white colored layer, and then, by removing the temporary support, and by transferring a light shielding layer onto a white colored layer from a film transfer material including at least a temporary support and the light shielding layer, and then, by removing the temporary support.

[Transfer Material for Forming White Decorative Material]

(Film Transfer: Film Transfer Material)

The transfer material for forming a white decorative material of the present invention includes the white colored layer using the pigment dispersion of the present invention. It is preferable that the transfer material for forming a white decorative material of the present invention is a film transfer material.

In an electrostatic capacitance type input device including an opening portion 8 having a configuration of FIG. 7, in a case where the white colored layer 2a, the light shielding layer 2b, or the like illustrated in FIG. 5 is formed by using a film transfer material, a resist component is not leaked from the opening portion even in the substrate (the front plate) including the opening portion, and in particular, the resist component is not leaked from a glass end in the white decorative material 2a formed by heating the white colored layer or the light shielding layer 2b in which it is necessary to form a light shielding pattern to the vicinity of the boundary of the front plate, and thus, the back side of the substrate is not contaminated, and a touch panel having an advantage such as a reduction in thickness/weight is able to be manufactured by a simple step.

It is preferable that the film transfer material includes a temporary support, a light shielding layer, and a white colored layer. Furthermore, it is preferable that the light shielding layer and the white colored layer of the film transfer material have the same composition as that of the light shielding layer and the white colored layer of the substrate attached with a white decorative material of the present invention, and the light shielding layer and the white colored layer of the film transfer material may have a different composition according to a manufacturing step after being transferred onto the substrate. For example, in a case where the light shielding layer and the white colored layer of the film transfer material contain a polymerizable compound, in the light shielding layer and the white decorative material formed by heating the white colored layer of the substrate attached with a white decorative material of the present invention, the content ratio of the polymerizable compound may be changed.

In addition, the colored layer included in the film transfer material contains at least a color material and a binder resin.

Hereinafter, in the film transfer material which is used in the substrate attached with a white decorative material of the present invention, a transfer material preparation method and each element configuring the film transfer material will be described in detail.

—Light Shielding Layer and White Colored Layer (Colored Layer)—

The film transfer material includes at least one of a light shielding layer or a white colored layer (hereinafter, also collectively referred to as a colored layer).

The light shielding layer and the white colored layer included in the transfer material are transferred onto a substrate described below, and thus, it is possible to form the light shielding layer and the white decorative material formed by heating the white colored layer of the substrate attached with a white decorative material of the present invention.

(1) Material of Colored Layer

The colored layer contains a color material and a binder resin material for forming a color material as a colored layer. In addition, it is preferable that the colored layer further contains a polymerizable compound and a polymerization initiator according to the environment and the application to be used. In addition, the colored layer is able to contain an antioxidant and a polymerization inhibitor.

(1-1) Color Material

The color materials which are used in the light shielding layer and the white decorative material formed by heating the white colored layer of the substrate attached with a white decorative material of the present invention are able to be respectively used as the color material of the film transfer material.

(1-2) Binder Resin

The binder resin of the film transfer material is not particularly limited except that the binder resin includes at least one type of silicone resin which is used in the light shielding layer and the white decorative material formed by heating the white colored layer of the substrate attached with a white decorative material of the present invention, and a silicone resin which is able to be transferred onto the substrate after forming the colored layer on the temporary support is able to be used as the binder resin.

(1-3) Antioxidant

An antioxidant may be added to the colored layer. In particular, in a case where the colored layer is a white colored layer, it is preferable that the antioxidant is added. A hindered phenolic antioxidant, a semi-hindered phenolic antioxidant, a phosphoric acid-based antioxidant, and a hybrid type antioxidant having phosphoric acid/hindered phenol in the molecules are able to be used as the antioxidant.

The phosphoric acid-based antioxidant, for example, IRGAFOS 168 (manufactured by BASF SE) is preferable as the antioxidant which is used in the present invention, from the viewpoint of suppressing coloration.

(1-4) Solvent

In addition, a solvent disclosed in paragraphs 0043 to 0044 of JP2011-95716A is able to be used as a solvent at the time of manufacturing the colored layer of a transfer film by coating. Specifically, cyclohexanone, methyl ethyl ketone, and the like are preferable.

(1-5) Additive

Further, other additives may be used in the colored layer. Examples of the additive include a surfactant disclosed in paragraph 0017 of JP4502784B and paragraphs 0060 to 0071 of JP2009-237362A, a thermal polymerization inhibitor disclosed in paragraph 0018 of JP4502784B, and other additives disclosed in paragraphs 0058 to 0071 of JP2000-310706A.

In addition, MEGAFAC F-780F (manufactured by DIC Corporation) and the like may be added as a coating auxiliary.

—Temporary Support—

The transfer material includes a temporary support.

A temporary support which has flexibility and is not considerably deformed, contracted, or stretched under pressurization, or pressurization and heating is preferable as the temporary support. Examples of such a temporary support are able to include a polyethylene terephthalate film, a tricellulose acetate film, a polystyrene film, a polycarbonate film, and the like, and among them, a biaxially stretched polyethylene terephthalate film is particularly preferable.

The thickness of the temporary support is not particularly limited, but is preferably 5 μm to 300 μm, and is more preferably 20 μm to 200 μm.

In addition, the temporary support may be transparent, and may contain dye silicon, alumina sol, a chromium salt, a zirconium salt, and the like.

In addition, conductivity is able to be provided to the temporary support by a method or the like disclosed in JP2005-221726A.

—Thermoplastic Resin Layer—

The transfer material may include at least one thermoplastic resin layer. It is preferable that the thermoplastic resin layer is disposed between the temporary support and the colored layer. That is, it is preferable that the transfer material includes the temporary support, the thermoplastic resin layer, and the colored layer in this order.

An organic polymer substance disclosed in JP1993-72724A (JP-H05-72724A) is preferable as a component which is used in the thermoplastic resin layer, and it is particularly preferable that the component is selected from organic polymer substances of which a softening point obtained by a Vicat method (specifically, a polymer softening point measurement method of American Society for Testing and Materials ASTMD1235) is lower than or equal to approximately 80° C.

Specifically, examples of the organic polymer substance include organic polymers such as polyolefin such as polyethylene and polypropylene, an ethylene copolymer such as ethylene and vinyl acetate, or a saponified product thereof, ethylene, and acrylic acid ester, or a saponified product thereof, a vinyl chloride copolymer such as polyvinyl chloride, vinyl chloride, vinyl acetate, and a saponified product thereof, polyvinylidene chloride, a vinylidene chloride copolymer, a styrene copolymer such as polystyrene, styrene, and (meth)acrylic acid ester, or a saponified product thereof, a vinyl toluene copolymer such as polyvinyl toluene, vinyl toluene, and (meth)acrylic acid ester, or a saponified product thereof, a (meth)acrylic acid ester copolymer such as poly(meth)acrylic acid ester, (meth)acrylic acid butyl, and vinyl acetate, and a polyamide resin such as vinyl acetate copolymer nylon, copolymerization nylon, N-alkoxy methylated nylon, and N-dimethyl aminated nylon.

The thickness of the thermoplastic resin layer is preferably 6 μm to 100 μm, and is more preferably 6 μm to 50 μm. By setting the thickness of the thermoplastic resin layer to be in a range of 6 μm to 100 μm, even in a case where irregularity is generated on the substrate, it is possible to completely absorb the irregularity.

—Intermediate Layer—

The transfer material may include at least one intermediate layer in order to prevent components from being mixed at the time of performing coating of a plurality of coated layers and at the time of storing the coated layer after the coating. It is preferable that the intermediate layer is disposed between the temporary support and the colored layer (in a case of including the thermoplastic resin layer, between the thermoplastic resin layer and the colored layer). That is, it is preferable that the transfer material includes the temporary support, the thermoplastic resin layer, the intermediate layer, and the colored layer in this order.

It is preferable that an oxygen blocking film having an oxygen blocking function, which is disclosed in JP1993-72724A (JP-H05-72724A) as a “separation layer”, is used as the intermediate layer, and in this case, sensitivity at the time of performing exposure increases, a time load of an exposure machine is reduced, and productivity is improved.

An oxygen blocking film which exhibits low oxygen permeability and is dispersed or dissolved in water or an alkaline aqueous solution is preferable as the oxygen blocking film, and the oxygen blocking film is able to be suitably selected from known oxygen blocking films. Among them, a combination of polyvinyl alcohol and polyvinyl pyrrolidone is particularly preferable.

The thickness of the intermediate layer is preferably 0.1 μm to 5.0 μm, and is more preferably 0.5 μm to 2.0 μm. By setting the thickness of the intermediate layer to be in a range of 0.1 μm to 5.0 μm, oxygen blocking power does not decrease, and much time is not taken at the time of performing development or at the time of removing the intermediate layer.

—Protective Peeling Layer—

It is preferable that a protective peeling layer (also referred to as a cover film) is disposed in the transfer material to cover the colored layer in order to protect the colored layer from being contaminated or damaged at the time of being stored. The protective peeling layer may be formed of a material which is identical to or different from the material of the temporary support, and has to be easily separated from the colored layer. For example, silicone paper, and a polyolefin or polytetrafluoroethylene sheet are suitable as the material of the protective peeling layer.

The maximum value of the degree of haze of the protective peeling layer is preferably less than or equal to 3.0%, and the maximum value is preferably less than or equal to 2.5%, is more preferably less than or equal to 2.0%, and is particularly preferably less than or equal to 1.0%, from the viewpoint of effectively suppressing the occurrence of a void after developing the colored layer.

The thickness of the protective peeling layer is preferably 1 μm to 100 μm, is more preferably 5 μm to 50 μm, and is particularly preferably 10 μm to 30 μm. In a case where the thickness is greater than or equal to 1 μm, the strength of the protective peeling layer becomes sufficient, and thus, the protective peeling layer is rarely broken at the time of bonding the cover film to a photosensitive resin layer. In a case where the thickness is less than or equal to 100 μm, the price of the protective peeling layer does not increase, and a wrinkle rarely occurs at the time of laminating the protective peeling layer.

Such a protective peeling layer is a commercially available product, and examples of the commercially available product include ALPHAN MA-410, ALPHAN E-200C, and ALPHAN E-501, manufactured by Oji Paper Co., Ltd., a polypropylene film manufactured by Shin-Etsu Film Co., Ltd. or the like, a polyethylene terephthalate film such as PS series, for example, PS-25 or the like, manufactured by TEIJIN LIMITED, and the like, but are not limited thereto. In addition, it is possible to simply manufacture the protective peeling layer by performing sand blast processing with respect to a commercially available film.

A polyolefin film such as a polyethylene film is able to be used as the protective peeling layer. In addition, in general, a polyolefin film which is used as the protective peeling layer is manufactured by a thermally melting, kneading, extruding, biaxial stretching, and casting or inflating a raw material.

As described above, the film transfer material which is able to be used in the present invention has been described, the film transfer material may be a negative material or a positive material, as necessary.

—Manufacturing Method of Film Transfer Material—

A manufacturing method of the film transfer material as described above is not particularly limited, and for example, the film transfer material is able to be manufactured by a step disclosed in paragraphs 0064 to 0066 of JP2005-3861A. In addition, the film transfer material, for example, is able to be prepared by a method disclosed in JP2009-116078A.

Examples of the manufacturing method of the film transfer material include a method including a step of applying a resin composition onto a temporary support, drying the resin composition, and forming a colored layer, and a step of covering the formed colored layer with the protective peeling layer.

Here, the film transfer material which is able to be used in the present invention may form at least two layers of a white colored layer and a light shielding layer as a colored layer, and in a case where a film transfer material including a temporary support and a white colored layer is transferred onto a substrate, and then, the temporary support is removed, and a film transfer material including at least a temporary support and a light shielding layer is transferred onto a white colored layer, at least one layer of the white colored layer or the light shielding layer may be formed as the colored layer. In the former case, in (the transfer material) of the present invention, a transfer material in which the white colored layer and the light shielding layer are laminated on a temporary support in this order may be used, and in this case, it is preferable that the white decorative material and the light shielding material are able to be disposed on a (glass) substrate at one time from the viewpoint of a process.

In the film transfer material which is able to be used in the present invention, other layers may be further formed unless contrary to the gist of the present invention. In addition, a thermoplastic resin layer and/or an intermediate layer (an oxygen blocking layer) may be formed by coating before the colored layer is formed.

A known coating method is able to be used as a method of applying a composition for forming a colored layer, a coating liquid for forming a thermoplastic resin layer, and a coating liquid for forming an intermediate layer onto a temporary support. For example, the layers are able to be formed by applying the coating liquids using a coating machine such as a spinner, a wheeler, a roller coater, a curtain coater, a knife coater, a wire bar coater, and an extruder, and by drying the coating liquids.

—Solvent—

A coloration photosensitive composition for forming a colored layer of a film transfer material is able to be preferably prepared by using a solvent along with each component contained in the coloration photosensitive composition.

Examples of the solvent include esters, for example, ethyl acetate, n-butyl acetate, isobutyl acetate, amyl formate, isoamyl acetate, isobutyl acetate, butyl propionate, isopropyl butyrate, ethyl butyrate, and butyl butyrate, alkyl esters, methyl lactate, ethyl lactate, methyl oxy acetate, ethyl oxy acetate, butyl oxy acetate, methyl methoxy acetate, ethyl methoxy acetate, butyl methoxy acetate, methyl ethoxy acetate, ethyl ethoxy acetate, alkyl 3-oxy propionic acid esters such as methyl 3-oxy propionate and ethyl 3-oxy propionate (for example, methyl 3-methoxy propionate, ethyl 3-methoxy propionate, methyl 3-ethoxy propionate, and ethyl 3-ethoxy propionate), alkyl 2-oxy propionic acid esters such as methyl 2-oxy propionate, ethyl 2-oxy propionate, and propyl 2-oxy propionate (for example, methyl 2-methoxy propionate, ethyl 2-methoxy propionate, propyl 2-methoxy propionate, methyl 2-ethoxy propionate, ethyl 2-ethoxy propionate, methyl 2-oxy-2-methyl propionate, ethyl 2-oxy-2-methyl propionate, methyl 2-methoxy-2-methyl propionate, and ethyl 2-ethoxy-2-methyl propionate), methyl pyruvate, ethyl pyruvate, propyl pyruvate, methyl acetoacetate, ethyl acetoacetate, methyl 2-oxobutanoate, ethyl 2-oxobutanoate, and the like;

ethers, for example, diethylene glycol dimethyl ether, tetrahydrofuran, ethylene glycol monomethyl ether, ethylene glycol monoethyl ether, methyl cellosolve acetate, ethyl cellosolve acetate, diethylene glycol monomethyl ether, diethylene glycol monoethyl ether, diethylene glycol monobutyl ether, propylene glycol monomethyl ether acetate, propylene glycol monoethyl ether acetate, propylene glycol propyl ether acetate, and the like;

ketones, for example, methyl ethyl ketone, methyl isobutyl ketone, cyclohexanone, 2-heptanone, 3-heptanone, and the like;

aromatic hydrocarbons, for example, toluene, xylene; and the like.

Among them, the methyl ethyl ketone, the methyl isobutyl ketone, the xylene, the cyclohexanone, the propylene glycol monomethyl ether, the propylene glycol monomethyl ether acetate, and the like are preferable.

Only one type of the solvent may be independently used, or two or more types thereof may be used in combination.

A method of covering the colored layer with the protective peeling layer is not particularly limited, and a method of superposing the protective peeling layer on the colored layer on the temporary support, and of pressure bonding the protective peeling layer and the colored layer to each other is able to be used.

A known laminator such as a laminator, a vacuum laminator, and an automatic cutting laminator which is able to further increase productivity is able to be used in the pressure bonding.

It is preferable that an atmospheric temperature is 20° C. to 45° C., and a line pressure is 1,000 N/m to 10,000 N/m as the conditions of the pressure bonding.

—Lamination Method—

The colored layer is transferred (bonded) onto the surface of the substrate by superposing the colored layer on the surface of the substrate, and by pressurizing and heating the colored layer and the substrate. A known laminator such as a laminator, a vacuum laminator, and an automatic cutting laminator which is able to further increase productivity is able to be used in the bonding.

A sheet type method of transferring a punched decorative material onto a substrate in which air bubbles do not enter between the substrate and the decorative material with high accuracy is preferable as a lamination method from the viewpoint of increasing a yield.

Specifically, examples of the lamination method are able to preferably include a method using a vacuum laminator.

Examples of a device which is used in (continuous/sheet type) lamination are able to include V-SE340aaH manufactured by CLIMB PRODUCTS CO., LTD, and the like.

Examples of a vacuum laminator device are able to include a vacuum laminator device manufactured by Takanoseiki Corporation, FVJ-540R and FV700 manufactured by Taisei Laminator Co., LTD., and the like.

By including a step of further laminating a support on the temporary support on a side opposite to the coloring agent before the film transfer material is bonded to the substrate, it is possible to obtain a preferred effect in which the air bubbles do not enter at the time of performing lamination. At this time, the support to be used is not particularly limited, and examples of the support are able to include the followings.

Examples of the support are able to include polyethylene terephthalate, polycarbonate, triacetyl cellulose, and a cycloolefin polymer.

In addition, the film thickness is able to be selected in a range of 50 μm to 200 μm.

—Step of Removing Temporary Support—

It is preferable that a manufacturing method of the film transfer material include a step of removing the temporary support from the transfer material bonded to the substrate.

—Step of Removing Thermoplastic Resin Layer and Step of Removing Intermediate Layer—

Further, in a case where the film transfer material includes a thermoplastic resin layer or an intermediate layer, it is preferable to include a step of removing the thermoplastic resin layer and the intermediate layer.

In general, the step of removing the thermoplastic resin layer and the intermediate layer is able to be performed by using an alkaline developer which is used in a photolithography system. The alkaline developer is not particularly limited, and a known developer such as a developer disclosed in JP1993-72724A (JP-H05-72724A) is able to be used. Furthermore, it is preferable that the developer allows the decorative material to have a soluble development behavior, and for example, it is preferable that a compound having pKa of 7 to 13 is contained at a concentration of 0.05 mol/L to 5 mol/L, and a water miscible organic solvent may be added in a small amount. Examples of the water miscible organic solvent are able to include methanol, ethanol, 2-propanol, 1-propanol, butanol, diacetone alcohol, ethylene glycol monomethyl ether, ethylene glycol monoethyl ether, ethylene glycol mono-n-butyl ether, benzyl alcohol, acetone, methyl ethyl ketone, cyclohexanone, ε-caprolactone, γ-butyrolactone, dimethyl formamide, dimethyl acetamide, hexamethyl phosphor amide, ethyl lactate, methyl lactate, ε-caprolactam, N-methyl pyrrolidone, and the like. It is preferable that the concentration of the organic solvent is 0.1 mass % to 30 mass %.

In addition, a known surfactant is able to be further added to the alkaline developer. It is preferable that the concentration of the surfactant is 0.01 mass % to 10 mass %.

A method of performing the step of removing the thermoplastic resin layer and the intermediate layer may be any one of paddling, shower, shower & spinning, dipping, and the like. Here, in the shower, the thermoplastic resin layer or the intermediate layer is able to be removed by spraying the developer using the shower. In addition, it is preferable that a washing agent or the like is sprayed by the shower after the development, and the residue is removed while being wiped with a brush or the like. It is preferable that a liquid temperature is 20° C. to 40° C., and it is preferable that pH is 8 to 13.

—Postbaking Step—

It is preferable that a postbaking step is included after the transfer step, and it is more preferable that the postbaking step is included after the step of removing the thermoplastic resin layer and the intermediate layer.

In the manufacturing method of the film transfer material, it is preferable that the white colored layer and the light shielding layer of the film transfer material are able to be formed by being heated at 50° C. to 300° C. under an environment of 0.08 atm to 1.2 atm from the viewpoint of making whiteness and productivity compatible.

In addition, the inner edge of the decorative material of the present invention includes the tilt portion formed such that the thickness of the decorative material becomes thin towards the inside of the light transmitting region, and it is preferable that the tilt portion is formed by contracting the light shielding layer by heating. For example, in the postbaking step, the light shielding layer is contracted by heating the decorative material at 50° C. to 300° C., and thus, the tilt portion is able to be formed.

It is more preferable that the heating in the postbaking is performed under an environment of higher than or equal to 0.5 atm. On the other hand, it is more preferable that the heating is performed under an environment of lower than or equal to 1.1 atm, and it is particularly preferable that the heating is performed under an environment of lower than or equal to 1.0 atm. Further, it is more particularly preferable that the heating is performed under an environment of approximately 1 atm (an atmospheric pressure) from the viewpoint of reducing manufacturing costs without using a special reduced pressure device. Here, in the related art, in a case where the white colored layer and the light shielding layer are formed by being heated and cured, the whiteness after performing the baking is maintained by decreasing the oxygen concentration under a reduced pressure environment of an extremely low pressure, but by using the film transfer material, it is possible to improve the tint (decrease the b value) of the white decorative material formed by heating the white colored layer of the substrate attached with a white decorative material of the present invention and the light shielding layer on the substrate side, and to increase the whiteness even after the baking is performed in the range of the pressure described above.

The temperature of the postbaking is preferably 50° C. to 300° C., is more preferably 100° C. to 300° C., and is even more preferably 120° C. to 300° C.

In addition, the postbaking may be performed at each of two or more different temperatures for a predetermined time. For example, first, heating is performed at 50° C. to 200° C., preferably at 100° C. to 200° C., and then, heating is able to be performed at 200° C. to 280° C., preferably at 220° C. to 260° C.

A time for performing the postbaking is more preferably 20 minutes to 150 minutes, and is particularly preferably 30 minutes to 100 minutes. In a case where the heating is performed at two or more temperature stages, and it is preferable that the total time for performing heating at each temperature stage is 20 minutes to 150 minutes.

The postbaking may be performed under an air environment, or may be performed under a nitrogen-substituted environment, and it is particularly preferable that the postbaking is performed under an air environment from the viewpoint of reducing the manufacturing costs without using a special reduced pressure device.

—Other Steps—

The manufacturing method of the film transfer material may include other steps such as a postexposure step.

In a case where the colored layer contains a photocurable resin, it is preferable that the postexposure step is included at the time of forming the white colored layer and the light shielding layer. The postexposure step may be performed only in a surface direction on a side in contact with the substrate of the white colored layer and the light shielding layer, may be performed only in a surface direction on a side not in contact with the transparent substrate, or may be performed in both surface directions.

Furthermore, a method disclosed in paragraphs 0035 to 0051 of JP2006-23696A is able to be preferably used in the present invention as an example of the exposure step, the development step, the step of removing the thermoplastic resin layer and the intermediate layer, and the other step.

(Thermal Transfer Printing)

In the thermal transfer printing, it is preferable that the white colored layer and the light shielding layer are respectively prepared by the thermal transfer printing of heating the temporary support side of the thermal transfer material including at least one of the white colored layer or the light shielding layer on the temporary support, and of transferring at least one of the white colored layer or the light shielding layer from the temporary support, and both of the white colored layer and the light shielding layer included in the thermal transfer material contain a resin having a siloxane bond in a main chain. Ink ribbon printing is preferable as a method of performing the thermal transfer printing. Examples of a method of performing the ink ribbon printing which is used in the manufacturing method of the substrate attached with a white decorative material of the present invention are able to include a method disclosed in “Nonimpact Printing—Technology and Material—(published by CMC Publishing Co., Ltd., Dec. 1, 1986)” or the like.

(Screen Printing)

In the screen printing, it is preferable that the white colored layer and the light shielding layer are prepared by the screen printing of the composition for forming a white colored layer or the composition for forming a light shielding layer, and both of the composition for forming a white colored layer and the composition for forming a light shielding layer contain a resin having a siloxane bond in a main chain. A method of performing the screen printing is not particularly limited, and a known method is able to be used, and for example, a method disclosed in JP4021925B, or the like is able to be used. In addition, by performing the screen printing a plurality of times, it is possible to make the film thickness thick even in the screen printing.

(Ink Jet Printing)

In the ink jet printing, it is preferable that the white colored layer and the light shielding layer are prepared by the ink jet printing of the composition for forming a white colored layer or the composition for forming a light shielding layer, and both of the composition for a white colored layer and the composition for forming a light shielding layer contain a resin having a siloxane bond in a main chain. Examples of a method of performing the ink jet printing which is used in the manufacturing method of the substrate attached with a white decorative material of the present invention are able to include a method disclosed in “Electronics Application of Ink Jet Technology (published by REALIZE Science & Engineering, Sep. 29, 2006)” or the like.

[Touch Panel]

The touch panel of the present invention includes the white decorative material of the present invention, and the white decorative material using the transfer material for forming a white decorative material of the present invention or the substrate attached with a white decorative material of the present invention.

It is preferable that such a touch panel is an electrostatic capacitance type input device.

<<Electrostatic Capacitance Type Input Device, and Image Display Device Including Electrostatic Capacitance Type Input Device as Constituent>>

It is preferable that the electrostatic capacitance type input device includes a front plate (also referred to as a substrate), and at least the following elements (1) to (4) on a non-contact side of the front plate, and includes the substrate attached with a white decorative material of the present invention as a laminate of the front plate (the substrate) and (1) a decorative material including a white decorative material formed by heating a white colored layer.

(1) A decorative material including a white decorative material formed by heating a white colored layer

(2) A plurality of first transparent electrode patterns which are formed by allowing a plurality of pad portions to extend in a first direction through a connection portion

(3) A plurality of second electrode patterns which are electrically insulated from the first transparent electrode pattern, and are formed of a plurality of pad portions formed by extending in a direction intersecting with the first direction

(4) An insulating layer electrically insulating the first transparent electrode pattern from the second electrode pattern

In addition, in the electrostatic capacitance type input device, the second electrode pattern may be a transparent electrode pattern.

Further, the electrostatic capacitance type input device may further includes the following element (5).

(5) A conductive element which is electrically connected to at least one of the first transparent electrode pattern or the second transparent electrode pattern, and is different from the first transparent electrode pattern and the second transparent electrode pattern

Further, it is preferable that the electrostatic capacitance type input device includes the front plate (the substrate), and (1) the decorative material including the white decorative material formed by heating the white colored layer, and includes the substrate attached with a white decorative material of the present invention as a laminate including at least one electrode pattern of the elements (2), (3), or (5) as a conductive layer.

It is preferable that (1) the decorative material including a white decorative material formed by heating a white colored layer further includes a light shielding layer.

<Configuration of Electrostatic Capacitance Type Input Device>

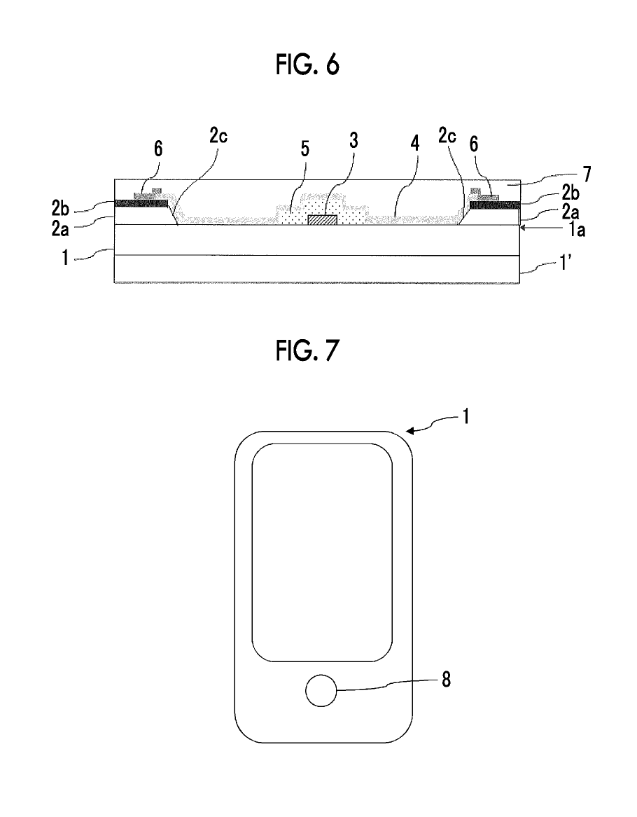

First, the configuration of the electrostatic capacitance type input device to be formed by the manufacturing method of the present invention will be described. FIG. 5 and FIG. 6 are sectional views illustrating a preferred configuration of the electrostatic capacitance type input device of the present invention. In FIG. 5, an electrostatic capacitance type input device 10 is configured of a front plate 1′ (cover glass), the white decorative material 2a formed by heating a white colored layer, the light shielding layer 2b, a first transparent electrode pattern 3, a second transparent electrode pattern 4, an insulating layer 5, a conductive element 6, and a transparent protective layer 7. The tilt portion 2c is disposed in the white decorative material 2a formed by heating the white colored layer, and the white decorative material 2a formed by heating the white colored layer is formed such that the thickness becomes thin towards the inside of the electrostatic capacitance type input device 10.

It is preferable that the front plate 1 and/or the front plate 1′ are configured of a light transmitting substrate. Any one of a light transmitting substrate in which a decorative material described below is disposed on the cover glass 1′, or a light transmitting substrate in which the decorative material described below is disposed on a film substrate in the order of the cover glass 1′ and the film substrate 1 is able to be used as the light transmitting substrate. A case where the decorative material is disposed on the cover glass is preferable from the viewpoint of thinning the touch panel, and a case where the decorative material is disposed on the film substrate, and the film substrate is bonded to the cover glass is preferable from the viewpoint of the productivity of the touch panel.

In addition, the cover glass 1′ is further disposed on a side of the film substrate opposite to the electrode. Reinforced glass or the like which is represented by GORILLA GLASS manufactured by Corning Incorporated is able to be used as the glass substrate. In addition, in FIG. 5 and FIG. 6, a side of the front plate 1 and/or the front plate 1′ on which each element is disposed will be referred to as a non-contact surface 1a. In the electrostatic capacitance type input device 10 of the present invention, input is performed by bringing a finger or the like into contact with a contact surface (la: a surface on a side opposite to the non-contact surface) of the front plate 1 and/or the front plate 1′. Hereinafter, the front plate may referred to as a “substrate”.

In addition, the white decorative material 2a formed by heating the white colored layer and the light shielding layer 2b are disposed on the non-contact surface of the front plate 1 and/or the front plate 1′. The white decorative material 2a formed by heating the white colored layer and the light shielding layer 2b as the decorative material are frame-like patterns around a light transmitting region (a display region) formed on the non-contact side of the front plate of the touch panel, and are formed such that routing wiring or the like is not observed or decoration is performed.

In the electrostatic capacitance type input device 10 of the present invention, a wiring taking out port (not illustrated) is able to be disposed. In a case where a substrate attached with a decorative material of an electrostatic capacitance type input device including a wiring taking out portion is formed, and a decorative material 2 is formed by using a liquid resist for forming a decorative material or screen printing ink, the leakage of a resist component from the wiring taking out portion or the bleed out of a resist component from a glass end of the decorative material occurs, and thus, a problem occurs in which a substrate back side is contaminated, but in a case where the substrate attached with a decorative material including the wiring taking out portion is used, such a problem is also able to be solved.

A plurality of first transparent electrode patterns 3 formed by allowing a plurality of pad portions to extend in the first direction through the connection portion, a plurality of second transparent electrode patterns 4 which are electrically insulated from the first transparent electrode pattern 3, and are formed of a plurality of pad portions formed by extending in the direction intersecting with the first direction, and the insulating layer 5 electrically insulating the first transparent electrode pattern 3 from the second transparent electrode pattern 4 are formed on the non-contact surface of the front plate 1 and/or the front plate 1′. The first transparent electrode pattern 3, the second transparent electrode pattern 4, and a conductive element 6 described below, for example, are able to be manufactured by a conductive metal oxide film having light transmittance, such as indium tin oxide (ITO) or indium zinc oxide (IZO). Examples of such a metal film include an ITO film; a metal film such as Al, Zn, Cu, Fe, Ni, Cr, and Mo; an metal oxide film such as SiO₂, and the like. At this time, it is possible to set the film thickness of each element to 10 nm to 200 nm. In addition, an amorphous ITO film is formed into a polycrystalline ITO film by calcination, and thus, it is possible to reduce electrical resistance. In addition, the first transparent electrode pattern 3, the second transparent electrode pattern 4, and the conductive element 6 described below are able to be manufactured by using a transfer film including a decorative material using the conductive fiber. In addition, in a case of forming the first conductive pattern or the like by using ITO or the like, it is possible to refer to paragraphs 0014 to 0016 or the like of JP4506785B.

In addition, at least one of the first transparent electrode pattern 3 or the second transparent electrode pattern 4 is able to be disposed over both regions of the non-contact surface of the front plate 1 and/or the front plate 1′ and the surface of the light shielding layer 2b on a side opposite to the front plate 1 and/or the front plate 1′. In FIG. 5 and FIG. 6, it is illustrated that the second transparent electrode pattern 4 is disposed over both regions of the non-contact surface of the front plate 1 and/or the front plate 1′ and the surface of the light shielding layer 2b on a side opposite to the front plate 1 and/or the front plate 1′, and the side surface of the white decorative material 2a formed by heating the white colored layer is covered with the second transparent electrode pattern 4. Here, the width of the white decorative material 2a formed by heating the white colored layer is able to be narrower than the width of the light shielding layer 2b, and in this case, at least one of the first transparent electrode pattern 3 or the second transparent electrode pattern 4 is able to be disposed over the region of the non-contact surface of the front plate 1 and/or the front plate 1′ and the surface of the white decorative material 2a formed by heating the white colored layer and the light shielding layer 2b on a side opposite to the front plate 1 and/or the front plate 1′. Thus, even in a case where a transfer film is laminated over the decorative material including the white decorative material 2a formed by heating the white colored layer and the light shielding layer 2b which are required to have a constant thickness and the back surface of the front plate, it is possible to perform lamination in which bubbles are not generated on the partial boundary of the decorative material 2 in a simple step, by using a film transfer material (in particular, the film transfer material including the thermoplastic resin layer) without using expensive equipment such as a vacuum laminator.

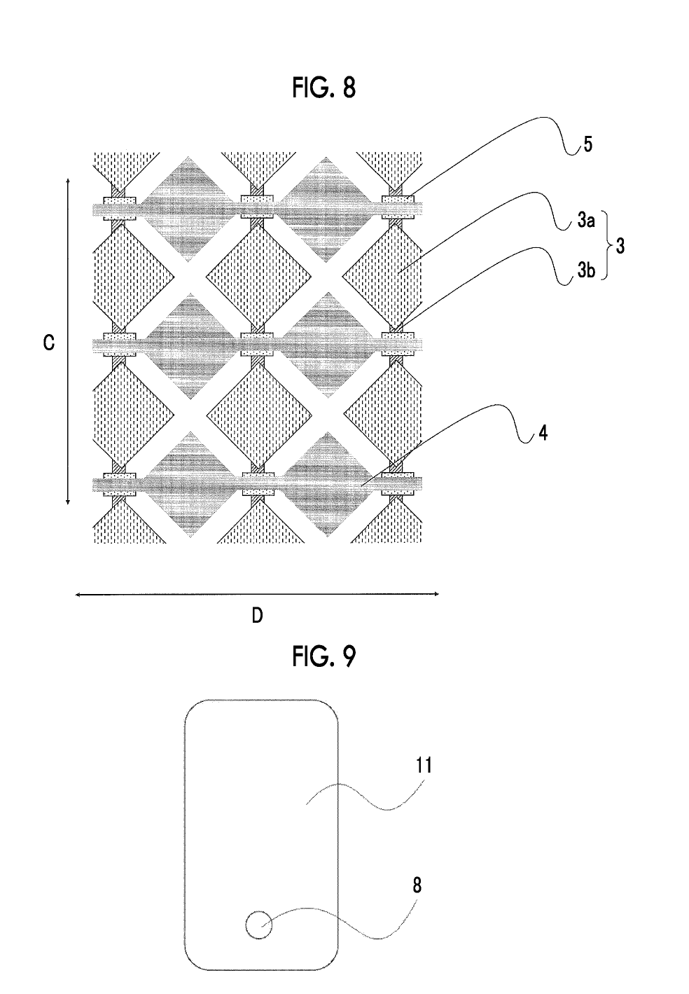

The first transparent electrode pattern 3 and the second transparent electrode pattern 4 will be described by using FIG. 8. FIG. 8 is an explanatory diagram illustrating an example of the first transparent electrode pattern and the second transparent electrode pattern of the present invention. As illustrated in FIG. 8, the first transparent electrode pattern 3 is formed by allowing a pad portion 3a to extending in the first direction through a connection portion 3b. In addition, the second transparent electrode pattern 4 is electrically insulated from the first transparent electrode pattern 3 by the insulating layer 5, and is configured of a plurality of pad portions formed by extending in the direction intersecting with the first direction (the second direction in FIG. 8). Here, in a case where the first transparent electrode pattern 3 is formed, the pad portion 3a and the connection portion 3b may be integrally prepared, or only the connection portion 3b may be prepared, and the pad portion 3a and the second transparent electrode pattern 4 may be integrally prepared (patterned). In a case where the pad portion 3a and the second transparent electrode pattern 4 are integrally prepared (patterned), as illustrated in FIG. 8, each layer is formed such that a part of the connection portion 3b and a part of the pad portion 3a are connected to each other, and the first transparent electrode pattern 3 and the second transparent electrode pattern 4 are electrically insulated from each other by the insulating layer 5.

In FIG. 5 and FIG. 6, the conductive element 6 is disposed on the surface of the light shielding layer 2b on a side opposite to the front plate 1 and/or the front plate 1b. The conductive element 6 is electrically connected to at least one of the first transparent electrode pattern 3 or the second transparent electrode pattern 4, and is an element different from the first transparent electrode pattern 3 and the second transparent electrode pattern 4. In FIG. 5 and FIG. 6, it is illustrated that the conductive element 6 is connected to the second transparent electrode pattern 4.

In addition, in FIG. 5 and FIG. 6, the transparent protective layer 7 is disposed to cover each entire constituent. The transparent protective layer 7 may be configured to cover only a part of each constituent. The insulating layer 5 and the transparent protective layer 7 may be formed of the same material, or may be formed of different materials. A material having high surface hardness and high heat resistance is preferable as the material configuring the insulating layer 5 and the transparent protective layer 7, and a known photosensitive siloxane resin material, a known acrylic resin material, and the like are used.

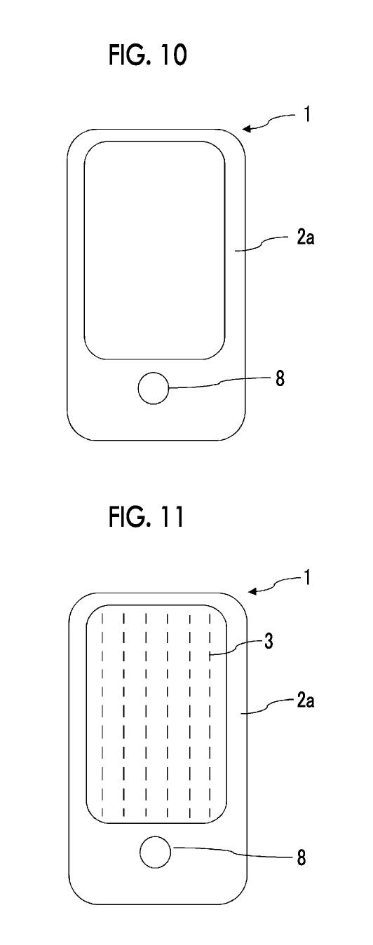

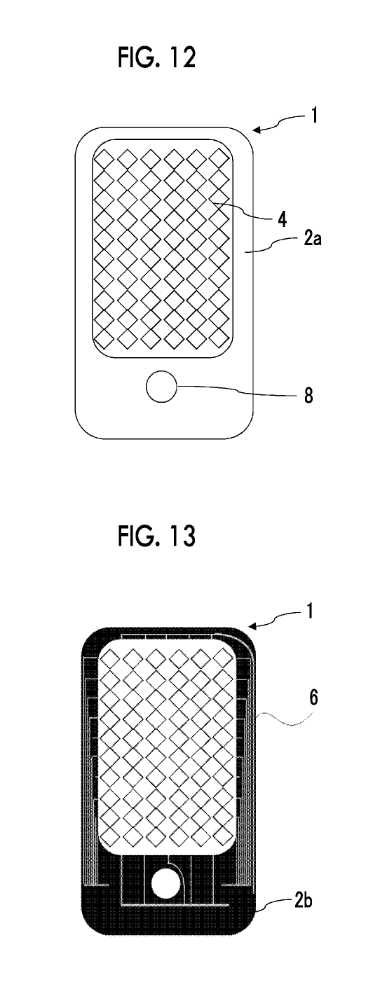

Examples of an embodiment formed in the process of the manufacturing method of the present invention are able to include embodiments of FIGS. 9 to 13. FIG. 9 is a top view illustrating an example of reinforced glass 11 on which the opening portion 8 is formed. FIG. 10 is a top view illustrating an example of a front plate on which the white decorative material 2a formed by heating the white colored layer is formed. FIG. 11 is a top view illustrating an example of a front plate on which the first transparent electrode pattern 3 is formed. FIG. 12 is a top view illustrating an example of a front plate on which the second transparent electrode pattern 4 is formed. FIG. 13 is a top view illustrating an example of a front plate on which the conductive element 6 different from the first transparent electrode pattern and the second transparent electrode pattern is formed. These drawings illustrate examples in which the above description is specified, and the range of the present invention is not restrictively interpreted by the drawings.

Configurations disclosed in “Latest Touch Panel Technology” (published by Technotimes Co., Ltd. on Jul. 6, 2009), supervised by Yuji MITANI, “Technology and Development of Touch Panel”, published by CMC Publishing Co., Ltd. (December, 2004), FPD International 2009 Forum T-11 Presentation Textbook, Cypress Semiconductor Corporation Application Note AN2292, and the like are able to be applied to the electrostatic capacitance type input device, and an image display device including the electrostatic capacitance type input device described above as a constituent.

[Information Display Device]

An information display device of the present invention includes the touch panel of the present invention. It is effective that the touch panel of the present invention is used as an OGS type touch panel.

A mobile device is preferable as the information display device which is able to use the touch panel of the present invention, and examples of the mobile device are able to include an information display device described below.

Examples of the mobile device include iPhone 4 and iPad (Registered Trademark, manufactured by Apple Inc.), Xperia (SO-01B) (Registered Trademark, manufactured by Sony Mobile Communications Inc.), Galaxy S (SC-02B) and Galaxy Tab (SC-01C) (Registered Trademark, manufactured by Samsung Electronics), BlackBerry 8707h (Registered Trademark, manufactured by Research In Motion Limited), Kindle (Registered Trademark, manufactured by Amazon.com, Inc.), and Kobo Touch (manufactured by Rakuten, Inc.).

### EXAMPLES

Hereinafter, the characteristics of the present invention will be described in detail with reference to examples and comparative examples. Materials, use amounts, ratios, treatment contents, treatment sequences, and the like of the following examples are able to be suitably changed unless the changes cause deviance from the gist of the present invention. Therefore, the range of the present invention will not be restrictively interpreted by the following specific examples.

Furthermore, unless otherwise particularly stated, “parts” indicates “parts by mass”, and wt % indicates mass %.

### Examples 1 to 92 and Comparative Examples 1 to 3

### Preparation of Pigment Dispersion and Heat Resistance Evaluation of White Decorative Material

(Material of Pigment Dispersing Agent)

A-1 used as an A component of a material of a pigment dispersing agent is X-22-174ASX (manufactured by Shin-Etsu Chemical Co., Ltd.), A-2 is X-22-174BX (manufactured by Shin-Etsu Chemical Co., Ltd.), and A-3 is KF-2012 (manufactured by Shin-Etsu Chemical Co., Ltd.). A-1, A-2, and A-3 are respectively structures denoted by General Formula described below (R represents an arbitrary substituent group or an arbitrary linking group, and n represents a natural number), A-1 has a functional group equivalent weight of 900 (g/mol), A-2 has a functional group equivalent weight of 2300 (g/mol), and A-3 has a functional group equivalent weight of 4600 (g/mol).

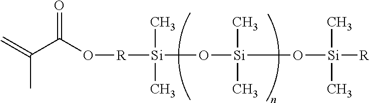

A-4 used as the A component of the material of the pigment dispersing agent is X-22-173BX (manufactured by Shin-Etsu Chemical Co., Ltd.). A-4 has a structure denoted by General Formula described below (R represents an arbitrary substituent group or an arbitrary linking group, and n represents a natural number).

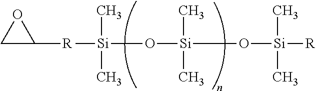

A-5 used as the A component of the material of the pigment dispersing agent is X-22-3710 (manufactured by Shin-Etsu Chemical Co., Ltd.). A-5 has a structure denoted by General Formula described below (R represents an arbitrary substituent group or an arbitrary linking group, and n represents a natural number).

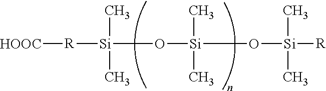

In Comparative Example 1, commercially available methyl methacrylate was used as the A component of the material of the pigment dispersing agent, in Comparative Example 2, pCL having structure described below was used as the A component of the material of the pigment dispersing agent described below, and in Comparative Example 3, commercially available polyacrylate was used as the pigment dispersing agent.

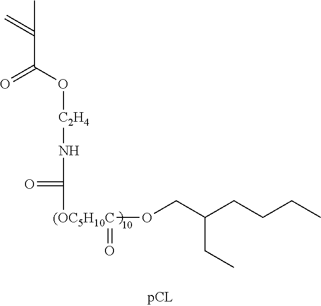

B-1 to B-5 used as a B component of the material of the pigment dispersing agent are compounds having structures shown in Table 1 described below.

TABLE 1

| | |
|---|---|
| B-1 | 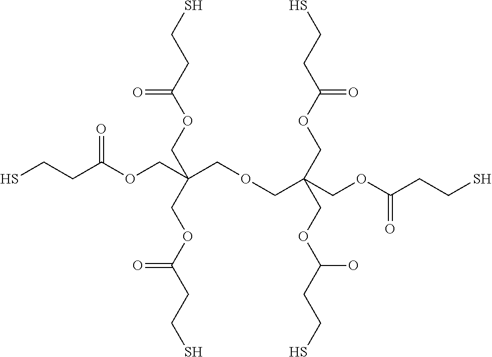 [SMILES: O=C(CCS)OCC(COCC(COC(=O)CCS)(COC(=O)CCS)COC(O)CCS)(COC(=O)CCS)COC(=O)CCS] |
| B-2 | 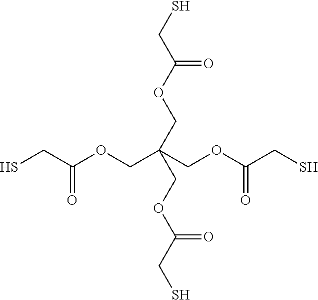 [SMILES: O=C(CS)OCC(COC(=O)CS)(COC(=O)CS)COC(=O)CS] |
| B-3 | 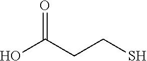 |
| B-4 | 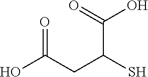 |
| B-5 | 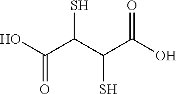 |

C-1 to C-30 used as a C component of the material of the pigment dispersing agent are compounds having the following structures.

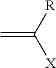

In General Formula described above, the structures represented by R and X were respectively shown in Table 2 described below.

TABLE 2

| | R | X |
|---|---|---|
| C-1 | CH₃ | COOH |
| C-2 | H | COOH |
| C-3 | CH₃ | COOC₂H₄OCOC₂H₂COOH |
| C-4 | H | C₈H₁₆COOH |
| C-5 | H | C₆H₄COOH |
| C-6 | CH₃ | COOC₂H₄OCOC₆H₄COOH |
| C-7 | CH2COOH | COOH |
| C-8 | CH₃ | PO₃H₂ |
| C-9 | H | PO₃H₂ |
| C-10 | CH₃ | COOC₂H₂OPO₃H₂ |
| C-11 | CH₃ | COOC₂H₂PO₃H₂ |
| C-12 | CH₃ | SO₃H |
| C-13 | H | SO₃H |
| C-14 | CH₃ | CONHCH₂C(CH₃)₂SO₃H |
| C-15 | H | C₆H₄SO₃H |
| C-16 | CH₃ | COOC₂H₂OH |
| C-17 | CH₃ | COOC₂CH(OH)CH₂OH |
| C-18 | CH₃ | COOC₂H₂OCOC₂H₂COCH₃ |
| C-19 | CH₃ | COOC₂H₂N(CH₃)₂ |
| C-20 | CH₃ | COOC₂H₂NHCONHC₃H₇ |
| C-21 | CH₃ | 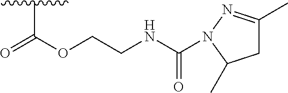 [SMILES: *C(=O)OCCNC(=O)N1N=C(C)CC1C] |
| C-22 | CH₃ | COOC₃H₆Si(OCH₃)₃ |
| C-23 | H | COOC₃H₆Si(OCH₃)₃ |
| C-24 | CH₃ | COOC₃H₆Si(OC₂H₅)₃ |
| C-25 | H | COOC₃H₆Si(OC₂H₅)₃ |
| C-26 | H | Si(OCH₃)₃ |
| C-27 | H | Si(OC₂H₅)₃ |
| C-28 | CH₃ | CONHC₃H₆N(CH₃)₂ |
| C-29 | H | C₆H₄NH₂ |
| C-30 | CH₃ | COOCH₂COCH₂COCH₃ |
| C-31 | CH₃ | COOC₂H₂OCOC₆H₁₀COOH |

D-1 to D-8 used as a D component of the material of the pigment dispersing agent are compounds having the following structures.

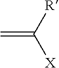

In General Formula described above, the structures represented by R′ and Y were respectively shown in Table 3 described below.

TABLE 3

| | R′ | Y |
|---|---|---|
| D-1 | CH3 | COOCH3 |
| D-2 | H | COOCH3 |
| D-3 | CH3 | COOC2H2CH(C2H5)C4H9 |
| D-4 | H | COOC2H2CH(C2H5)C4H9 |
| D-5 | CH3 | COOnBu |
| D-6 | H | COOnBu |
| D-7 | CH3 | COOBn |
| D-8 | H | COOBn |

(Synthesis of Pigment Dispersing Agent X-1)

“X-22-174ASX (manufactured by Shin-Etsu Chemical Co., Ltd.)” as a polymerization component (A-1) having a silicone chain, and a chain transfer agent (B-1) were dissolved in propylene glycol monomethyl ether acetate (hereinafter, simply referred to as PGMEA) according to Table 4 described below, a polymerization initiator (dimethyl-2,2′-azobis(2-methyl propionate) “V-601”) was dissolved at a ratio of 0.3 mol % with respect to the total of polymerization components, and polymerization was performed at 80° C. under a nitrogen atmosphere. In the middle of the process, a polymerization initiator (V-601) was added at a ratio of 0.3 mol % with respect to the total of polymerization components after 2 hours from the initiation of the polymerization, and polymerization was performed for 4 hours.

The obtained reaction solution and a polymerization component (C-1) having a pigment adsorption portion were dissolved in PGMEA, a polymerization initiator (dimethyl-2,2′-azobis(2-methyl propionate) “V-601”) was dissolved at a ratio of 0.3 mol % with respect to the total of polymerization components, and polymerization was performed at 80° C. under a nitrogen atmosphere. In the middle of the process, a polymerization initiator (V-601) was added at a ratio of 0.3 mol % with respect to the total of polymerization components after 2 hours from the initiation of the polymerization, and polymerization was performed for 4 hours. A purification treatment and drying were performed after the polymerization, and thus, a pigment dispersing agent X-1 was obtained.

(Pigment Dispersing Agents X-2 to X-42 and X-76 to X-80, and Synthesis of Comparative Examples 1 and 2)

Pigment dispersing agents X-2 to X-42 and X-76 to X-80, and Comparative Examples 1 and 2 were obtained by the same method as that of the pigment dispersing agent X-1 except that the polymerization component and the ratio thereof were changed according to Tables 4 to 6 described below.

The pigment dispersing agents X-2 to X-42, X-76 to X-80, and Comparative Examples 1 and 2 have a structure denoted by General Formula 2.

(Synthesis of Pigment Dispersing Agents X-43)

“X-22-174BX (manufactured by Shin-Etsu Chemical Co., Ltd.)” as a polymerization component (A-2) having a silicone chain, and a methacrylic acid (C-1) as the polymerization component having a pigment adsorption portion were dissolved in PGMEA according to Table 5 described below, a polymerization initiator (dimethyl-2,2′-azobis(2-methyl propionate) “V-601”) was dissolved at a ratio of 0.3 mol % with respect to the total of polymerization components, and polymerization was performed at 80° C. under a nitrogen atmosphere. In the middle of the process, a polymerization initiator (V-601) was added at a ratio of 0.3 mol % with respect to the total of polymerization components after 2 hours and 4 hours from the initiation of the polymerization, and polymerization was performed for 6 hours in total. A purification treatment and drying were performed after the polymerization, and thus, a pigment dispersing agent X-43 was obtained.

(Synthesis of Pigment Dispersing Agents X-44 to X-67 and X-75, and X-81 to X-89)

Pigment dispersing agents X-44 to X-67 and X-75, and X-81 to X-89 were obtained by the same method as that of the pigment dispersing agent X-43 except that the polymerization component and the ratio thereof were changed according to Tables 4 to 6 described below.

The structure of the pigment dispersing agents X-44 to X-67 and X-75, and X-81 to X-89 is a copolymer containing a copolymerization component having a partial structure denoted by General Formula 1 and a copolymerization component having a pigment adsorption portion.

(Synthesis of Pigment Dispersing Agent X-68)

“X-22-174ASX (manufactured by Shin-Etsu Chemical Co., Ltd.)” as a polymerization component having a silicone chain and a chain transfer agent (B-3) were dissolved in PGMEA according to Table 6 described below, a polymerization initiator (dimethyl-2,2′-azobis(2-methyl propionate) “V-601”) was dissolved at a ratio of 0.3 mol % with respect to the total of polymerization components, and polymerization was performed at 80° C. under a nitrogen atmosphere. In the middle of the process, a polymerization initiator (V-601) was added at a ratio of 0.3 mol % with respect to the total of polymerization components after 2 hours from the initiation of the polymerization, and polymerization was performed for 4 hours. A purification treatment and drying were performed after the polymerization, and thus, a pigment dispersing agent X-68 was obtained.

(Synthesis of Pigment Dispersing Agents X-69 to X-74)

Pigment dispersing agents X-69 to X-74 were obtained by the same method as that of the pigment dispersing agent X-68 except that the polymerization component and the ratio thereof were changed according to Tables 4 to 6 described below.

The pigment dispersing agents X-69 to X-74 have a structure denoted by General Formula 3.

(Preparation of Pigment Dispersion)

A pigment dispersing agent, titanium oxide (rutile type titanium oxide particles which were subjected to a surface treatment with alumina and zirconia, and a primary particle diameter of 0.25 μm), xylene were mixed at a ratio shown in Tables 4 to 6 described below, and dispersion was performed for 2 hours with a bead mill by using a zirconia bead having a diameter of 0.5 mm, and thus, pigment dispersions of Examples 1 to 92 and Comparative Examples 1 to 3 were obtained.

(Preparation of White Layer-Coated Sample)

15.7 parts of each of the obtained pigment dispersions were mixed with 82.4 parts of a silicone resin solution (KR251, manufactured by Shin-Etsu Chemical Co., Ltd.), 0.11 parts of a coating auxiliary (F-780F, manufactured by DIC Corporation), and 1.7 parts of methyl ethyl ketone, spin coating was performed such that a dried film having a thickness of 20 μm was formed on white plate glass having a thickness of 0.7 mm, and thus, a white layer-coated sample for evaluation was obtained.

The appearance of the obtained white layer-coated sample was visually observed, and thus, the occurrence of abnormality such as an aggregate was confirmed.

(Appearance Evaluation)

The appearance of the obtained white layer-coated sample was visually observed.

As a result thereof, in the white layer-coated samples using the pigment dispersions of Examples 1 to 92, a white coated object having glossiness was obtained. It is considered that the reason that the appearance is excellent is because the dispersibility of the pigment is excellent.

(Preparation of White Decorative Material and Heat Resistance Evaluation)

After that, the white layer-coated sample was subjected to a heat treatment three times at 150° C. for 30 minutes, at 240° C. for 30 minutes, and at 280° C. for 40 minutes, and the sample which had been subjected to the heat treatment three times was set to a sample for heat resistance evaluation. The obtained sample for heat resistance evaluation after being subjected to the heat treatment was set to a white decorative material of each of the examples and the comparative examples.

The reflection spectrum of the sample for heat resistance evaluation on the glass side was measured by using a spectrophotometer attached with an integrating sphere, and color coordinates L*a*b* were calculated on the basis of the measured reflection spectrum. L* mainly indicates the brightness of the sample for heat resistance evaluation, a* mainly indicates the redness of the sample for heat resistance evaluation, and b* mainly indicates the yellowness of the sample for heat resistance evaluation.

By using b* which was easily affected by a heat treatment as an index,

a sample for heat resistance evaluation having b* of less than −1.3 was set to heat resistance A,

a sample for heat resistance evaluation having b* of greater than or equal to −1.3 and less than −0.9 was set to heat resistance B,

a sample for heat resistance evaluation having b* of greater than or equal to −0.9 and less than −0.5 was set to heat resistance C, and

a sample for heat resistance evaluation having b* of greater than or equal to −0.5 was set to heat resistance D.

Practically, it is necessary that the heat resistance has the evaluation of A, B, or C, the evaluation of A or B is preferable, and the evaluation of A is more preferable.

TABLE 4

| Dispersing Agent | | | | | | | | |
|---|---|---|---|---|---|---|---|---|
| | | | | | Added Amount | TiO₂ | Solvent | Heat |
| Type | A/(Mass %) | B/(Mass %) | C/(Mass %) | D/(Mass %) | (Mass %) | (Mass %) | (Mass %) | Resistance |

| | | | | | | | | |
|---|---|---|---|---|---|---|---|---|
| Example 1 | X-1 | A-1/78 wt % | B-1/17 wt % | C-1/5 wt % | 3.5 | 70 | 26.5 | A |
| Example 2 | X-2 | A-1/60 wt % | B-1/25 wt % | C-1/15 wt % | 3.5 | 70 | 26.5 | B |
| Example 3 | X-3 | A-2/90 wt % | B-1/7 wt % | C-1/3 wt % | 3.5 | 70 | 26.5 | A |
| Example 4 | X-4 | A-3/90 wt % | B-1/7 wt % | C-1/3 wt % | 3.5 | 70 | 26.5 | A |
| Example 5 | X-5 | A-1/78 wt % | B-1/17 wt % | C-2/5 wt % | 3.5 | 70 | 26.5 | A |
| Example 6 | X-6 | A-1/60 wt % | B-1/25 wt % | C-2/15 wt % | 3.5 | 70 | 26.5 | B |
| Example 7 | X-7 | A-2/90 wt % | B-1/7 wt % | C-2/3 wt % | 3.5 | 70 | 26.5 | A |
| Example 8 | X-8 | A-3/90 wt % | B-1/7 wt % | C-2/3 wt % | 3.5 | 70 | 26.5 | A |
| Example 9 | X-9 | A-4/90 wt % | B-1/7 wt % | C-2/3 wt % | 3.5 | 70 | 26.5 | A |
| Example 10 | X-10 | A-5/90 wt % | B-1/7 wt % | C-2/3 wt % | 3.5 | 70 | 26.5 | A |
| Example 11 | X-11 | A-2/90 wt % | B-1/7 wt % | C-3/3 wt % | 3.5 | 70 | 26.5 | A |
| Example 12 | X-12 | A-2/90 wt % | B-1/7 wt % | C-4/3 wt % | 3.5 | 70 | 26.5 | A |
| Example 13 | X-13 | A-2/90 wt % | B-1/7 wt % | C-5/3 wt % | 3.5 | 70 | 26.5 | A |
| Example 14 | X-14 | A-2/90 wt % | B-1/7 wt % | C-6/3 wt % | 3.5 | 70 | 26.5 | A |
| Example 15 | X-15 | A-2/90 wt % | B-1/7 wt % | C-7/3 wt % | 3.5 | 70 | 26.5 | A |
| Example 16 | X-16 | A-2/90 wt % | B-1/7 wt % | C-8/3 wt % | 3.5 | 70 | 26.5 | A |
| Example 17 | X-17 | A-2/90 wt % | B-1/7 wt % | C-9/3 wt % | 3.5 | 70 | 26.5 | A |
| Example 18 | X-18 | A-2/90 wt % | B-1/7 wt % | C-10/3 wt % | 3.5 | 70 | 26.5 | B |
| Example 19 | X-19 | A-2/90 wt % | B-1/7 wt % | C-11/3 wt % | 3.5 | 70 | 26.5 | A |
| Example 20 | X-20 | A-2/90 wt % | B-1/7 wt % | C-12/3 wt % | 3.5 | 70 | 26.5 | A |
| Example 21 | X-21 | A-2/90 wt % | B-1/7 wt % | C-14/3 wt % | 3.5 | 70 | 26.5 | B |
| Example 22 | X-22 | A-2/90 wt % | B-1/7 wt % | C-15/3 wt % | 3.5 | 70 | 26.5 | A |
| Example 23 | X-23 | A-1/78 wt % | B-1/17 wt % | C-16/5 wt % | 3.5 | 70 | 26.5 | A |
| Example 24 | X-24 | A-1/60 wt % | B-1/25 wt % | C-16/15 wt % | 3.5 | 70 | 26.5 | B |
| Example 25 | X-25 | A-2/90 wt % | B-1/7 wt % | C-16/3 wt % | 3.5 | 70 | 26.5 | A |
| Example 26 | X-26 | A-3/90 wt % | B-1/7 wt % | C-16/3 wt % | 3.5 | 70 | 26.5 | A |
| Example 27 | X-27 | A-2/90 wt % | B-2/7 wt % | C-16/3 wt % | 3.5 | 70 | 26.5 | A |
| Example 28 | X-28 | A-1/78 wt % | B-1/17 wt % | C-17/5 wt % | 3.5 | 70 | 26.5 | A |
| Example 29 | X-29 | A-2/90 wt % | B-1/7 wt % | C-17/3 wt % | 3.5 | 70 | 26.5 | A |
| Example 30 | X-30 | A-2/90 wt % | B-1/7 wt % | C-18/3 wt % | 3.5 | 70 | 26.5 | A |
| Example 31 | X-31 | A-2/90 wt % | B-1/7 wt % | C-19/3 wt % | 3.5 | 70 | 26.5 | A |

TABLE 5

| | Dispersing Agent | | | | | | | | |
|---|---|---|---|---|---|---|---|---|---|
| | | | | | | Added Amount | TiO₂ | Solvent | Heat |
| | Type | A/(Mass %) | B/(Mass %) | C/(Mass %) | D/(Mass %) | (Mass %) | (Mass %) | (Mass %) | Resistance |
| Example 32 | X-32 | A-2/90 wt % | B-1/7 wt % | C-22/3 wt % | | 3.5 | 70 | 26.5 | A |
| Example 33 | X-33 | A-2/90 wt % | B-1/7 wt % | C-23/3 wt % | | 3.5 | 70 | 26.5 | A |
| Example 34 | X-34 | A-2/90 wt % | B-1/7 wt % | C-24/3 wt % | | 3.5 | 70 | 26.5 | A |
| Example 35 | X-35 | A-2/90 wt % | B-1/7 wt % | C-25/3 wt % | | 3.5 | 70 | 26.5 | A |
| Example 36 | X-36 | A-2/90 wt % | B-1/7 wt % | C-26/3 wt % | | 3.5 | 70 | 26.5 | A |
| Example 37 | X-37 | A-2/90 wt % | B-1/7 wt % | C-27/3 wt % | | 3.5 | 70 | 26.5 | A |
| Example 38 | X-38 | A-2/90 wt % | B-1/7 wt % | C-28/3 wt % | | 3.5 | 70 | 26.5 | A |
| Example 39 | X-39 | A-2/90 wt % | B-1/7 wt % | C-29/3 wt % | | 3.5 | 70 | 26.5 | A |
| Example 40 | X-40 | A-2/90 wt % | B-1/7 wt % | C-30/3 wt % | | 3.5 | 70 | 26.5 | A |
| Example 41 | X-41 | A-2/70 wt % | B-1/30 wt % | | | 3.5 | 70 | 26.5 | A |
| Example 42 | X-42 | A-2/95 wt % | B-1/5 wt % | | | 3.5 | 70 | 26.5 | A |
| Example 43 | X-43 | A-1/90 wt % | | C-1/10 wt % | | 3.5 | 70 | 26.5 | A |
| Example 44 | X-44 | A-1/50 wt % | | C-1/30 wt % | D-1/20 wt % | 3.5 | 70 | 26.5 | B |
| Example 45 | X-45 | A-2/90 wt % | | C-1/10 wt % | | 3.5 | 70 | 26.5 | A |
| Example 46 | X-46 | A-3/90 wt % | | C-1/10 wt % | | 3.5 | 70 | 26.5 | A |
| Example 47 | X-47 | A-1/90 wt % | | C-2/10 wt % | | 3.5 | 70 | 26.5 | A |
| Example 48 | X-48 | A-2/90 wt % | | C-3/10 wt % | | 3.5 | 70 | 26.5 | A |
| Example 49 | X-49 | A-2/90 wt % | | C-5/10 wt % | | 3.5 | 70 | 26.5 | A |
| Example 50 | X-50 | A-2/50 wt % | | C-6/30 wt % | D-2/20 wt % | 3.5 | 70 | 26.5 | B |
| Example 51 | X-51 | A-2/50 wt % | | C-8/30 wt % | D-3/20 wt % | 3.5 | 70 | 26.5 | B |
| Example 52 | X-52 | A-2/90 wt % | | C-8/10 wt % | | 3.5 | 70 | 26.5 | A |
| Example 53 | X-53 | A-2/90 wt % | | C-10/10 wt % | | 3.5 | 70 | 26.5 | A |
| Example 54 | X-54 | A-2/90 wt % | | C-11/10 wt % | | 3.5 | 70 | 26.5 | A |
| Example 55 | X-55 | A-2/90 wt % | | C-12/10 wt % | | 3.5 | 70 | 26.5 | A |
| Example 56 | X-56 | A-1/90 wt % | | C-16/10 wt % | | 3.5 | 70 | 26.5 | A |
| Example 57 | X-57 | A-1/50 wt % | | C-16/30 wt % | D-1/20 wt % | 3.5 | 70 | 26.5 | B |
| Example 58 | X-58 | A-2/90 wt % | | C-16/10 wt % | | 3.5 | 70 | 26.5 | A |
| Example 59 | X-59 | A-3/50 wt % | | C-16/30 wt % | D-1/20 wt % | 3.5 | 70 | 26.5 | B |
| Example 60 | X-60 | A-2/50 wt % | | C-17/30 wt % | D-4/20 wt % | 3.5 | 70 | 26.5 | B |
| Example 61 | X-61 | A-2/50 wt % | | C-20/30 wt % | D-5/20 wt % | 3.5 | 70 | 26.5 | B |
| Example 62 | X-62 | A-2/90 wt % | | C-21/10 wt % | | 3.5 | 70 | 26.5 | A |

TABLE 6

| | Dispersing Agent | | | | | | | | |
|---|---|---|---|---|---|---|---|---|---|
| | | | | | | Added Amount | | Solvent | Heat |
| | Type | A/(Mass %) | B/(Mass %) | C/(Mass %) | D/(Mass %) | (Mass %) | TiO₂ (Mass %) | (Mass %) | Resistance |
| Example 63 | X-63 | A-2/90 wt % | | C-22/10 wt % | | 3.5 | 70 | 26.5 | A |
| Example 64 | X-64 | A-2/90 wt % | | C-23/10 wt % | | 3.5 | 70 | 26.5 | A |
| Example 65 | X-65 | A-2/90 wt % | | C-24/10 wt % | | 3.5 | 70 | 26.5 | A |
| Example 66 | X-66 | A-2/90 wt % | | C-25/10 wt % | | 3.5 | 70 | 26.5 | A |
| Example 67 | X-67 | A-3/50 wt % | | C-30/30 wt % | D-8/20 wt % | 3.5 | 70 | 26.5 | B |
| Example 68 | X-68 | A-1/90 wt % | B-3/10 wt % | | | 3.5 | 70 | 26.5 | A |
| Example 69 | X-69 | A-2/95 wt % | B-3/5 wt % | | | 3.5 | 70 | 26.5 | A |
| Example 70 | X-70 | A-3/98 wt % | B-3/2 wt % | | | 3.5 | 70 | 26.5 | A |
| Example 71 | X-71 | A-1/90 wt % | B-4/10 wt % | | | 3.5 | 70 | 26.5 | A |
| Example 72 | X-72 | A-2/95 wt % | B-4/5 wt % | | | 3.5 | 70 | 26.5 | A |
| Example 73 | X-73 | A-3/98 wt % | B-4/2 wt % | | | 3.5 | 70 | 26.5 | A |
| Example 74 | X-74 | A-3/98 wt % | B-5/2 wt % | | | 3.5 | 70 | 26.5 | A |
| Example 75 | X-3 | A-2/90 wt % | B-1/7 wt % | C-1/3 wt % | | 10 | 70 | 16.5 | A |
| Example 76 | X-44 | A-1/50 wt % | | C-1/30 wt % | D-1/20 wt % | 10 | 70 | 16.5 | A |
| Example 77 | X-44 | A-1/50 wt % | | C-1/30 wt % | D-1/20 wt % | 15 | 70 | 11.5 | A |
| Example 78 | X-75 | A-1/40 wt % | | C-1/40 wt % | D-1/20 wt % | 3.5 | 70 | 26.5 | C |
| Example 79 | X-76 | A-1/72 wt % | B-1/21 wt % | C-1/7 wt % | | 3.5 | 70 | 26.5 | A |
| Example 80 | X-77 | A-1/87 wt % | B-1/10 wt % | C-1/3 wt % | | 3.5 | 70 | 26.5 | A |
| Example 81 | X-78 | A-1/93 wt % | B-1/5 wt % | C-1/2 wt % | | 3.5 | 70 | 26.5 | A |
| Example 82 | X-79 | A-2/81 wt % | B-1/9 wt % | C-6/10 wt % | | 3.5 | 70 | 26.5 | A |
| Example 83 | X-80 | A-3/90 wt % | B-1/5 wt % | C-6/5 wt % | | 3.5 | 70 | 26.5 | A |
| Example 84 | X-81 | A-1/78 wt % | | C-1/12 wt % | D-1/10 wt % | 3.5 | 70 | 26.5 | A |
| Example 85 | X-82 | A-2/78 wt % | | C-1/12 wt % | D-1/10 wt % | 3.5 | 70 | 26.5 | A |
| Example 86 | X-83 | A-3/78 wt % | | C-1/12 wt % | D-1/10 wt % | 3.5 | 70 | 26.5 | A |
| Example 87 | X-84 | A-2/78 wt % | | C-6/12 wt % | D-1/10 wt % | 3.5 | 70 | 26.5 | A |
| Example 88 | X-85 | A-2/78 wt % | | C-3/12 wt % | D-1/10 wt % | 3.5 | 70 | 26.5 | A |
| Example 89 | X-86 | A-2/78 wt % | | C-31/12 wt % | D-1/10 wt % | 3.5 | 70 | 26.5 | A |
| Example 90 | X-87 | A-2/78 wt % | | C-16/12 wt % | D-1/10 wt % | 3.5 | 70 | 26.5 | A |
| Example 91 | X-88 | A-2/93 wt % | | C-1/4 wt % | D-1/3 wt % | 3.5 | 70 | 26.5 | A |
| Example 92 | X-89 | A-3/88 wt % | | C-1/12 wt % | | 3.5 | 70 | 26.5 | A |
| Comparative | Comparative | MMA/78 wt % | B-1/17 wt % | C-7/5 wt % | | 3.5 | 70 | 26.5 | D |
| Example 1 | Example 1 | | | | | | | | |
| Comparative | Comparative | pCL/78 wt % | B-1/17 wt % | C-7/5 wt % | | 3.5 | 70 | 26.5 | D |
| Example 2 | Example 2 | | | | | | | | |
| Comparative | Polyacrylate | | | | | 3.5 | 70 | 26.5 | D |
| Example 3 | | | | | | | | | |

From Table 4 to Table 6 described above, it was found that the pigment dispersion of the present invention had excellent heat resistance.

From Comparative Examples 1 to 3, it was found that the pigment dispersion using the pigment dispersing agent not having the partial structure denoted by General Formula (1) had poor heat resistance.

### Examples 100-A and 100-B, and Comparative Example 4

### Preparation of Pigment Dispersion Containing Different Solvent and Appearance Evaluation

A dispersing agent, titanium oxide (rutile type titanium oxide particles which were subjected to a surface treatment with alumina and zirconia, and a primary particle diameter of 0.25 μm), and a solvent were mixed at a ratio shown in Table 7 described below, and dispersion was performed for 2 hours with a bead mill by using a zirconia bead having a diameter of 0.5 mm, and thus, pigment dispersions of Examples 100-A and 100-B and Comparative Example 4 were obtained.

Dimethyl silicone oil used in Comparative Example 4 is SHIN-ETSU SILICONE KF-96 (Product Name, manufactured by Shin-Etsu Chemical Co., Ltd., dimethyl silicone oil of 100 mass %), and has a structure in which all of a side chain and a terminal of polysiloxane are methyl groups.

Compositions are shown in Table 7 described below along with the pigment dispersion of Example 1 described above.

TABLE 7

| | Added Amount of | | |
|---|---|---|---|
| | Dispersing Agent | | |
| | (Mass %) | TiO₂ (Mass %) | Solvent/(Mass %) |
| Example 1 | X-1/3.5 | 70 | Xylene/26.5 |
| Example 100-A | X-1/3.5 | 70 | Methyl Ethyl |
| | | | Ketone/26.5 |
| Example 100-B | X-1/3.5 | 70 | PGMEA*/ |
| | | | 26.5 |
| Comparative | X-1/3.5 | 70 | Dimethyl Silicone |
| Example 4 | | | Oil/26.5 |

*PGMEA represents propylene glycol monomethyl ether acetate.

15.7 parts of each of the obtained pigment dispersions were mixed with 82.4 parts of a silicone resin solution 1 (KR251, manufactured by Shin-Etsu Chemical Co., Ltd.), 0.11 parts of a coating auxiliary (F-780, manufactured by DIC Corporation), and 1.7 parts of methyl ethyl ketone, spin coating was performed such that a dried film having a thickness of 20 μm was formed on white plate glass having a thickness of 0.7 mm, and thus, a white layer-coated sample for evaluation was obtained.

(Evaluation of Appearance)

The appearance of the obtained white layer-coated sample was visually observed.

As a result thereof, in the white layer-coated samples using the pigment dispersions of Example 1 and Example 100-A, a white coated object having glossiness was obtained. It is considered that the reason that the appearance is excellent is because the dispersibility of the pigment is excellent.

The white layer-coated sample using the pigment dispersion of Example 100-B was white and had glossiness in a lot of portions on the surface, and a part of the surface was roughened, but the degree was practically allowable.

In contrast, in the white layer-coated sample using the pigment dispersion of Comparative Example 4 not containing any one of a hydrocarbon-based solvent, a ketone-based solvent, an ester-based solvent, and an alcohol-based solvent, the surface was roughened without having glossiness, and the color was changed to an ash gray color. It is considered that the reason that the appearance deteriorates is because the dispersibility of the pigment deteriorates.

(Heat Resistance Evaluation)

Furthermore, in Example 1, preparation of white decorative materials of Examples 100-A and 100-B and Comparative Example 4, and heat resistance evaluation were performed by the same method as that in Example 1 except that each of pigment dispersions of Examples 100-A and 100-B and Comparative Example 4 was used instead of the pigment dispersion of Example 1. As a result thereof, the white decorative materials of Examples 100-A and 100-B, and the white decorative material of Comparative Example 4 had the evaluation of A.

### Examples 101 to 114

### Preparation of White Decorative Material Using Pigment Dispersion of Present Invention

(Preparation of Black Coloring Liquid for Light Shielding Layer and White Coloring Liquid)

Black coloring liquids 1 to 3 for a light shielding layer shown in the following table, and white coloring liquids 1 to 12 shown in Table 9 described below were prepared by using the following materials. The numerical values shown in Table 8 and Table 9 indicate parts by mass.

TABLE 8

| | | | Black |
|---|---|---|---|
| | Black Coloring | Black Coloring | Coloring |
| | Liquid 1 | Liquid 2 | Liquid 3 |
| Black Dispersion 1 | 240.0 | 240.0 | 240.0 |
| Silicone Resin Solution 1 | 130.2 | 127.5 | |
| Silicone Resin Solution 2 | 108.5 | 106.2 | |
| Silicone Resin Solution 3 | | | 255.0 |
| Polymerization Catalyst 1 | | 11.3 | 11.1 |
| Coating Auxiliary | 0.24 | 0.24 | 0.24 |
| Cyclohexanone | 269.1 | 269.1 | 247.9 |
| Methyl Ethyl Ketone | 251.8 | 245.8 | 245.8 |
| Total | 999.84 | 1000.14 | 1000.04 |

TABLE 9

| | White | White | White | White | White | White |
|---|---|---|---|---|---|---|
| | Coating | Coating | Coating | Coating | Coating | Coating |
| | Liquid 1 | Liquid 2 | Liquid 3 | Liquid 4 | Liquid 5 | Liquid 6 |
| Pigment | 167.1 | 167.1 | 167.1 | 167.1 | 167.1 | 167.1 |
| Dispersion of | | | | | | |
| Example 1 | | | | | | |
| Silicone Resin | | | | | | |
| Solution 1 | | | | | | |
| Silicone Resin | | | | | | |
| Solution 2 | | | | | | |
| Silicone Resin | | | | | | |
| Solution 3 | | | | | | |
| Silicone Resin | 772.1 | 764.5 | 735.4 | 701.9 | 671.4 | 643.5 |
| Solution 4 | | | | | | |
| Silicone Resin | 22.1 | 21.8 | 21.0 | 20.1 | 19.2 | 18.4 |
| Solution 5 | | | | | | |
| Polymerization | | 7.0 | 33.6 | 64.2 | 92.1 | 117.7 |
| Catalyst 1 | | | | | | |
| Polymerization | | | | | | |
| Catalyst 2 | | | | | | |
| Polymerization | | | | | | |
| Catalyst 3 | | | | | | |
| Polymerization | | | | | | |
| Catalyst 4 | | | | | | |
| Antioxidant | 0.3 | 0.3 | 0.3 | 0.3 | 0.3 | 0.3 |
| Coating | 1.2 | 1.2 | 1.2 | 1.2 | 1.2 | 1.2 |
| Auxiliary | | | | | | |
| Methyl Ethyl | 37.2 | 38.0 | 41.4 | 45.2 | 48.7 | 51.9 |
| Ketone | | | | | | |
| | White | White | White | White | White | White |
| | Coating | Coating | Coating | Coating | Coating | Coating |
| | Liquid 7 | Liquid 8 | Liquid 9 | Liquid 10 | Liquid 11 | Liquid 12 |
| Pigment | 167.1 | 167.1 | 167.1 | 370.9 | 370.9 | 314.3 |
| Dispersion of | | | | | | |
| Example 1 | | | | | | |
| Silicone Resin | | | | 187.8 | 313.0 | |
| Solution 1 | | | | | | |
| Silicone Resin | | | | 365.2 | 260.8 | |
| Solution 2 | | | | | | |
| Silicone Resin | | | | | | 530.5 |
| Solution 3 | | | | | | |
| Silicone Resin | 764.5 | 764.5 | 764.5 | | | |
| Solution 4 | | | | | | |
| Silicone Resin | 21.8 | 21.8 | 21.8 | | | |
| Solution 5 | | | | | | |
| Polymerization | | | | 12.5 | 12.5 | 10.6 |
| Catalyst 1 | | | | | | |
| Polymerization | 1.7 | | | | | |
| Catalyst 2 | | | | | | |
| Polymerization | | 1.7 | | | | |
| Catalyst 3 | | | | | | |
| Polymerization | | | 1.7 | | | |
| Catalyst 4 | | | | | | |
| Antioxidant | 0.3 | 0.3 | 0.3 | 0.6 | 0.6 | 0.5 |
| Coating | 1.2 | 1.2 | 1.2 | 2.4 | 2.4 | 2.0 |
| Auxiliary | | | | | | |
| Methyl Ethyl | 43.3 | 43.3 | 43.3 | 60.7 | 39.9 | 142.1 |
| Ketone | | | | | | |

Black Dispersion 1 (GC4151, manufactured by Sanyo Color Works, LTD., Cyclohexanone Dispersion of Carbon Black (Non-Volatile Component of 20.7 mass %))
Silicone Resin Solution 1 (KR300, manufactured by Shin-Etsu Chemical Co., Ltd., Xylene Solution of Silicone Resin (Non-Volatile Component of 50 mass %))
Silicone Resin Solution 2 (KR311, manufactured by Shin-Etsu Chemical Co., Ltd., Xylene Solution of Silicone Resin (Non-Volatile Component of 60 mass %))
Silicone Resin Solution 3 (KR255, manufactured by Shin-Etsu Chemical Co., Ltd., Xylene Solution of Silicone Resin (Non-Volatile Component of 50 mass %))
Silicone Resin Solution 4 (KR251, manufactured by Shin-Etsu Chemical Co., Ltd., Toluene Solution of Silicone Resin (Non-Volatile Component of 20 mass %))
Silicone Resin Solution 5 (X-40-9246, manufactured by Shin-Etsu Chemical Co., Ltd., Silicone Oligomer (100 mass %))
Polymerization Catalyst 1 (D-15, manufactured by Shin-Etsu Chemical Co., Ltd., Xylene Solution of Zinc-Containing Catalyst (solid content 25 mass %))
Polymerization Catalyst 2 (Iron (III) Triacetyl Acetonate)
Polymerization Catalyst 3 (Aluminum (III) Triacetyl Acetonate)
Polymerization Catalyst 4 (Dibutoxy zirconium (IV) Diacetyl Acetonate)
Antioxidant (IRGAFOS 168, manufactured by BASF SE, Compound Described below)

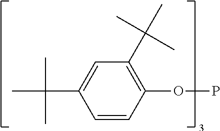

Coating Auxiliary (MEGAFAC F-780F, manufactured by DIC Corporation, Methyl Ethyl Ketone Solution of Surfactant (Non-Volatile Component of 30 mass %))

<Preparation of Transfer Material for Forming Decorative Material>

<<Preparation of Peeling Film>>

The following peeling film was prepared as a temporary support attached with a peeling layer of a transfer material.

UNIPEEL TR6 (manufactured by UNITIKA LTD., an olefin-based peeling layer in which a matting agent protrudes from a peeling layer by 200 nm is provided on a PET film having a thickness of 75 μm)

<<Preparation of Protective Film>>

Next, a protective film described below was prepared.

ALPHAN E-501 (manufactured by Oji F-Tex Co., Ltd., a polypropylene film having a thickness of 12 μm)

<Preparation of Color Material Layer onto Temporary Support (Transfer Layer Formed of Light Shielding Layer and White Colored Layer)>

Any one of the black coloring liquids 1 to 3 for forming a light shielding layer shown in the table described above was applied onto the peeling layer of the temporary support attached with a peeling layer by using an extrusion type coating machine such that a dry thickness became 3.0 μm, and was dried.

Any one of the white coloring liquids 1 to 12 for forming a white colored layer shown in the table described above was applied onto the light shielding layer such that a dry thickness became 35.0 μm, and was dried. The protective film described above was pressure-bonded onto the white colored layer.

Thus, transfer materials 101 to 114 formed of the light shielding layer and the white layer, shown in Table 10 described below, in which the temporary support, and the light shielding layer and the white colored layer were integrated with each other were prepared. The obtained transfer materials 101 to 114 were respectively set to transfer materials for forming a white decorative material of Examples 101 to 114.

TABLE 10

| | | | Black Coloring | |
|---|---|---|---|---|
| | | | Liquid for Light | White Coloring Liquid |
| | Transfer Material | Configuration of Transfer Material | Shielding Layer | for White Colored Layer |
| Preparation Example | Transfer Material | Lamination of Light Shielding | Black Coloring | White Coloring Liquid 1 |
| 101 | 101 | Layer and White Colored Layer | Liquid 2 | |
| Preparation Example | Transfer Material | Lamination of Light Shielding | Black Coloring | White Coloring Liquid 2 |
| 102 | 102 | Layer and White Colored Layer | Liquid 2 | |
| Preparation Example | Transfer Material | Lamination of Light Shielding | Black Coloring | White Coloring Liquid 3 |
| 103 | 103 | Layer and White Colored Layer | Liquid 2 | |
| Preparation Example | Transfer Material | Lamination of Light Shielding | Black Coloring | White Coloring Liquid 4 |
| 104 | 104 | Layer and White Colored Layer | Liquid 2 | |
| Preparation Example | Transfer Material | Lamination of Light Shielding | Black Coloring | White Coloring Liquid 5 |
| 105 | 105 | Layer and White Colored Layer | Liquid 2 | |
| Preparation Example | Transfer Material | Lamination of Light Shielding | Black Coloring | White Coloring Liquid 6 |
| 106 | 106 | Layer and White Colored Layer | Liquid 2 | |
| Preparation Example | Transfer Material | Lamination of Light Shielding | Black Coloring | White Coloring Liquid 7 |
| 107 | 107 | Layer and White Colored Layer | Liquid 2 | |
| Preparation Example | Transfer Material | Lamination of Light Shielding | Black Coloring | White Coloring Liquid 8 |
| 108 | 108 | Layer and White Colored Layer | Liquid 2 | |
| Preparation Example | Transfer Material | Lamination of Light Shielding | Black Coloring | White Coloring Liquid 9 |
| 109 | 109 | Layer and White Colored Layer | Liquid 2 | |
| Preparation Example | Transfer Material | Lamination of Light Shielding | Black Coloring | White Coloring Liquid |
| 110 | 110 | Layer and White Colored Layer | Liquid 2 | 10 |
| Preparation Example | Transfer Material | Lamination of Light Shielding | Black Coloring | White Coloring Liquid |
| 111 | 111 | Layer and White Colored Layer | Liquid 2 | 11 |
| Preparation Example | Transfer Material | Lamination of Light Shielding | Black Coloring | White Coloring Liquid |
| 112 | 112 | Layer and White Colored Layer | Liquid 2 | 12 |
| Preparation Example | Transfer Material | Lamination of Light Shielding | Black Coloring | White Coloring Liquid 2 |
| 113 | 113 | Layer and White Colored Layer | Liquid 1 | |
| Preparation Example | Transfer Material | Lamination of Light Shielding | Black Coloring | White Coloring Liquid 2 |
| 114 | 114 | Layer and White Colored Layer | Liquid 3 | |

### Preparation of Substrate Attached with Decorative Material

### Example 101

Reinforced glass (300 mm×400 mm×0.7 mm) on which an opening portion (15 mmΦ) was formed as illustrated in FIG. 7 was washed with a rotary brush including a nylon brush while spraying a glass washing agent liquid of which the temperature was adjusted to be 25° C. by a shower for 20 seconds. The glass substrate was preheated at 90° C. for 2 minutes in a substrate preheating device.

The transfer material 101 of Preparation Example 101, which was laminated with the light shielding layer and the white layer, was formed into the shape of a frame having a size corresponding to four sides of the glass substrate, and then, was transferred onto the glass substrate described above. After that, the temporary support of the transfer material 101 was peeled off. In order to cure the light shielding layer and the white colored layer, the obtained film was heated at 150° C. for 30 minutes along with a glass substrate (a substrate), and was further heated at 240° C. for 30 minutes. Accordingly, a substrate attached with a white decorative material of Example 101 including a white decorative material formed by heating a white colored layer was obtained.

### Preparation of Substrate Attached with Decorative Material

### Examples 102 to 114

In Example 101, substrates attached with a white decorative material of Examples 102 to 114, in which the light shielding layer and the white colored layer were formed on the glass substrate, were obtained by the same method as that in Example 101 except that the material of the used white coloring liquid for a white colored layer and the material of the used black coloring liquid for a light shielding layer were changed as shown in Table 10 described above.

<Evaluation>

An evaluation method of the properties of the substrate attached with a white decorative material of each of the examples obtained as described above will be described below. In addition, the obtained results were respectively shown in Table 11 described below.

(Measurement of Taper Tilt Angle)

A curve configuring the tilt surface of a tilt portion on the sectional surface of the obtained substrate attached with a white decorative material was approximated to a straight line, and the straight line was set to a tilt angle θ. The tilt angle θ was obtained from the result of observing the sectional shape with an electron microscope.

(Appearance Evaluation)

In the obtained substrate attached with a white decorative material, appearance evaluation was performed on the basis of the following criteria. In practice, an allowable level is A and B.

A: In a case where the substrate attached with a white decorative material is visually observed from a side including the white decorative material, a positional difference between the end portion of the white decorative material and the end portion of the light shielding layer is not able to be observed, and even in a case where the substrate attached with a white decorative material is visually observed from a side opposite to the side including the white decorative material, a portion having low transmission density is not able to be observed in the vicinity of the end portion of the white decorative material.

B: In a case where the substrate attached with a white decorative material is visually observed from the side including the white decorative material, a positional difference between the end portion of the white decorative material and the end portion of the light shielding layer is able to be observed, but in a case where the substrate attached with a white decorative material is visually observed from the side opposite to the side including the white decorative material, a portion having low transmission density is not able to be observed in the vicinity of the end portion of the white decorative material.

C: In a case where the substrate attached with a white decorative material is visually observed from the side including the white decorative material, a positional difference between the end portion of the white decorative material and the end portion of the light shielding layer is able to be observed, and in a case where the substrate attached with a white decorative material is visually observed from the side opposite to the side including the white decorative material, a portion having low transmission density is able to be observed in the vicinity of the end portion of the white decorative material.

D: A part of the light shielding layer bleeds out from the end portion of the white layer decorative material.

(ITO Conductivity)

A transparent electrode layer was formed in a portion including a taper tilt portion on the substrate attached with a white decorative material by the following method, and evaluation was performed according to the number of disconnections thereof.

((Formation of Transparent Electrode Layer))

The substrate attached with a white decorative material of each of the examples was introduced into a vacuum chamber, and an ITO thin film having a thickness of 40 nm was formed by DC magnetron sputtering (Conditions: Temperature of Substrate of 250° C., Argon Pressure of 0.13 Pa, and Oxygen Pressure of 0.01 Pa) using an ITO target (indium:tin=95:5 (Molar Ratio)) in which the content ratio of SnO₂ was 10 mass %, and thus, a front plate was obtained in which the transparent electrode layer was formed. The surface resistance of the ITO thin film was 80Ω/.

((Preparation of Transfer Film E1 for Etching))

A thermoplastic resin layer and an intermediate layer were formed on a temporary support by the following method.

A coating liquid for a thermoplastic resin layer formed of a formulation H1 described below was applied onto a polyethylene terephthalate film temporary support having a thickness of 75 μm by using a slit-like nozzle, and was dried. Next, a coating liquid for an intermediate layer formed of a formulation P1 described below was applied thereonto, and was dried.

—Coating Liquid for Thermoplastic Resin Layer: Formulation H1—
Methanol: 11.1 parts by mass
Propylene Glycol Monomethyl Ether Acetate: 6.36 parts by mass
Methyl Ethyl Ketone: 52.4 parts by mass
Methyl Methacrylate/2-Ethyl Hexyl Acrylate/Benzyl Methacrylate/Methacrylic Acid Copolymer (Copolymerization Compositional Ratio (Molar Ratio)=55/11.7/4.5/28.8, Molecular Weight=100,000, and Tg≅70° C.): 5.83 parts by mass
Styrene/Acrylic Acid Copolymer (Copolymerization Compositional Ratio (Molar Ratio)=63/37, Weight-Average Molecular Weight=10,000, and Tg≅100° C.): 13.6 parts by mass
Monomer (Product Name: BPE-500, manufactured by Shin Nakamura Chemical Co., Ltd.): 9.1 parts by mass
Coating Auxiliary (MEGAFAC F-780F, manufactured by DIC Corporation): 0.54 parts by mass

Furthermore, the viscosity of a coating liquid H1 for a thermoplastic resin layer at 120° C. after a solvent was removed therefrom was 1,500 Pa·sec.

—Coating Liquid for Intermediate Layer: Formulation P1—
Polyvinyl Alcohol: 32.2 parts by mass (Product Name: PVA205, manufactured by KURARAY CO., LTD., Degree of Saponification=88%, and Degree of Polymerization of 550)
Polyvinyl Pyrrolidone: 14.9 parts by mass (Product Name: K-30, manufactured by Ashland Japan Co., Ltd.)
Distilled Water: 524 parts by mass
Methanol: 429 parts by mass

(Preparation of Transfer Film E1 for Etching)

A coating liquid for a photocurable resin layer for etching formed of the formulation E1 described below was applied onto the substrate including the thermoplastic resin layer and the intermediate layer on the temporary support, and was dried. A protective film was pressure-bonded thereto, and thus, a transfer film E1 for etching was obtained in which the temporary support, the thermoplastic resin layer, the intermediate layer (an oxygen blocking film), the photocurable resin layer for etching, and the protective film for etching were integrated with each other (the film thickness of the photocurable resin layer for etching was 2.0 μm).

—Coating Liquid for Photocurable Resin Layer for Etching: Formulation E1—
Methyl Methacrylate/Styrene/Methacrylic Acid Copolymer (Copolymer Composition (Mass %): 31/40/29, Mass Average Molecular Weight of 60000, and Acid Value of 163 mgKOH/g): 16 parts by mass
Monomer 1 (Product Name: BPE-500, manufactured by Shin Nakamura Chemical Co., Ltd.): 5.6 parts by mass
Adduct of 0.5 moles of Tetraethylene Oxide Monomethacrylate of Hexamethylene Diisocyanate: 7 parts by mass
Cyclohexane Dimethanol Monoacrylate: 2.8 parts by mass
2-Chloro-N-Butyl Acridone: 0.42 parts by mass
2,2-Bis(o-Chlorophenyl)-4,4′,5,5′-Tetraphenyl Biimidazole: 2.17 parts by mass
Leuco Crystal Violet: 0.26 parts by mass
Phenothiazine: 0.013 parts by mass
Coating Auxiliary (Product Name: MEGAFAC F-780F, manufactured by DIC Corporation): 0.03 parts by mass
Methyl Ethyl Ketone: 40 parts by mass
1-Methoxy-2-Propanol: 20 parts by mass

(Formation of Transparent Electrode Pattern)

The front plate in which the white decorative material, the light shielding layer, and the transparent electrode layer were formed was washed, and the transfer film E1 for etching from which the protective film was removed was laminated thereon (Substrate Temperature: 130° C., Rubber Roller Temperature of 120° C., Line Pressure of 100 N/cm, and Transport Speed of 2.2 m/minute). The temporary support was peeled off, and then, a distance between the surface of an exposure mask (a quartz exposure mask having a transparent electrode pattern) and the photocurable resin layer for etching was set to 200 μm, and pattern exposure was performed at an exposure amount of 50 mJ/cm² (an i line) into the shape of a stripe in which a line width was 40 μm, and the number of lines was 20.

Next, the front plate attached with a transparent electrode layer pattern including a photocurable resin layer pattern for etching was dipped in a resist peeling bath into which a resist peeling liquid (N-methyl-2-pyrrolidone, monoethanol amine, a surfactant (Product Name: SURFYNOL 465, manufactured by Air Products and Chemicals, Inc.), and a liquid temperature of 45° C.) was put, and was treated for 200 seconds, and the photocurable resin layer for etching was removed, and thus, a front plate was obtained in which the white decorative material, the light shielding layer, and 20 stripe-like transparent electrode patterns disposed over both regions of the non-contact surface of the front plate and the surface of the light shielding layer on a side opposite to the front plate as illustrated in FIG. 5 were formed. In the transparent electrode pattern formed on the light shielding layer of the substrate attached with a decorative material of each of the examples and the comparative examples prepared as described above, the occurrence of the disconnection was measured by prober inspection, and evaluation was performed on the basis of the following criteria. In practice, an allowable level is A.

A: In the prepared 20 transparent electrode patterns, no disconnection was confirmed.

B: In the prepared 20 transparent electrode patterns, the disconnection was confirmed in one or more patterns.

TABLE 11

| | Transfer | Tilt Angle | Appearance | |
|---|---|---|---|---|
| | Material | (Degrees) | Evaluation | ITO Conductivity |
| Example 101 | Preparation | 15 | B | A |
| | Example 101 | | | |
| Example 102 | Preparation | 25 | B | A |
| | Example 102 | | | |
| Example 103 | Preparation | 33 | B | A |
| | Example 103 | | | |
| Example 104 | Preparation | 42 | A | A |
| | Example 104 | | | |
| Example 105 | Preparation | 52 | A | A |
| | Example 105 | | | |
| Example 106 | Preparation | 29 | B | A |
| | Example 106 | | | |
| Example 107 | Preparation | 28 | B | A |
| | Example 107 | | | |
| Example 108 | Preparation | 23 | B | A |
| | Example 108 | | | |
| Example 109 | Preparation | 10 | B | A |
| | Example 109 | | | |
| Example 110 | Preparation | 15 | B | A |
| | Example 110 | | | |
| Example 111 | Preparation | 23 | B | A |
| | Example 111 | | | |
| Example 112 | Preparation | 27 | B | A |
| | Example 112 | | | |
| Example 113 | Preparation | 31 | B | A |
| | Example 113 | | | |
| Example 114 | Preparation | 32 | B | A |
| | Example 114 | | | |

From Table 11 described above, in the substrates attached with a white decorative material prepared by Examples 101 to 114, the light shielding layer did not bleed out from the end portion of the white decorative material, and a resin having low transmission density was not observed, and thus, the appearance was excellent, and the conductivity of ITO was excellent, and therefore, the substrates attached with a white decorative material prepared by Examples 101 to 114 were preferable as a white decorative material for a front plate-integrated touch panel.

### Example 121

### Preparation of Touch Panel

<Formation of First Transparent Electrode Pattern>

(Formation of Transparent Electrode Layer)

The substrate attached with a white decorative material of Example 101 was introduced into a vacuum chamber, and an ITO thin film having a thickness of 40 nm was formed by DC magnetron sputtering (Conditions: Temperature of Substrate of 250° C., Argon Pressure of 0.13 Pa, and Oxygen Pressure of 0.01 Pa) using an ITO target (indium:tin=95:5 (Molar Ratio)) in which the content ratio of SnO₂ was 10 mass %, and thus, a front plate was obtained in which the transparent electrode layer was formed. The surface resistance of the ITO thin film was 80Ω/.

(Formation of First Transparent Electrode Pattern)

The front plate in which the white decorative material, the light shielding layer, and the transparent electrode layer were formed was washed, and the transfer film E1 for etching from which the protective film was removed was laminated thereon (Substrate Temperature: 130° C., Rubber Roller Temperature of 120° C., Line Pressure of 100 N/cm, and Transport Speed of 2.2 m/minute). The temporary support was peeled off, and then, a distance between the surface of an exposure mask (a quartz exposure mask having a transparent electrode pattern) and the photocurable resin layer for etching was set to 200 μm, and pattern exposure was performed at an exposure amount of 50 mJ/cm² (an i line).

Next, a treatment was performed at 25° C. for 100 seconds by using a triethanol amine-based developer (a liquid in which T-PD2 (Product Name, manufactured by Fujifilm Corporation) containing 30 mass % of triethanol amine was diluted 10 times with pure water), a treatment was performed at 33° C. for 20 seconds by using a surfactant-containing washing liquid (a liquid in which T-SD3 (Product Name, manufactured by Fujifilm Corporation) was diluted 10 times with pure water), and the residue in the thermoplastic resin layer and the intermediate layer was removed by a rotary brush and an ultra high pressure washing nozzle, and a postbaking treatment was further performed at 130° C. for 30 minutes, and thus, a front plate was obtained in which the white decorative material, the light shielding layer, the transparent electrode layer, and the photocurable resin layer pattern for etching were formed.

The front plate in which the white decorative material, the light shielding layer, the transparent electrode layer, and the photocurable resin layer pattern for etching were formed was dipped in an etching bath into which an ITO echant (a hydrochloric acid, an aqueous solution of potassium chloride, and a liquid temperature of 30° C.) was put, a treatment was performed for 100 seconds, and the transparent electrode layer in an exposed region which was not covered with the photocurable resin layer for etching was removed by being dissolved, and thus, a front plate attached with a white layer, a light shielding layer, and a transparent electrode layer pattern including a photocurable resin layer pattern for etching was obtained.

Next, the front plate attached with a transparent electrode layer pattern including the photocurable resin layer pattern for etching was dipped in a resist peeling bath into which a resist peeling liquid (N-methyl-2-pyrrolidone, monoethanol amine, a surfactant (Product Name: SURFYNOL 465, manufactured by Air Products and Chemicals, Inc.), and a liquid temperature of 45° C.) was put, a treatment was performed for 200 seconds, and the photocurable resin layer for etching was removed, and thus, a front plate was obtained in which the white layer, the light shielding layer, and first transparent electrode patterns disposed over both regions of the non-contact surface of the front plate and the surface of the light shielding layer on a side opposite to the front plate as illustrated in FIG. 5 were formed.

<Formation of Insulating Layer>

(Preparation of Transfer Film W1 for Forming Insulating Layer)

In the preparation of transfer film E1 for etching, a transfer film W1 for forming an insulating layer in which the temporary support, the thermoplastic resin layer, the intermediate layer (an oxygen blocking film), the photocurable resin layer for an insulating layer, and the protective film were integrated with each other was obtained by the same preparation as that of the transfer film E1 for etching except that the etching resist E1 was changed to a coating liquid for forming an insulating layer formed of a formulation W1 described below (the film thickness of the photocurable resin layer for an insulating layer was 1.4 μm).

—Coating Liquid for Forming Insulating Layer: Formulation W1—
Binder 3 (1-Methoxy-2-Propanol of Glycidyl Methacrylate Adduct (d) of Cyclohexyl Methacrylate (a)/Methyl Methacrylate (b)/Methacrylic Acid Copolymer (c) (Composition (Mass %): a/b/c/d=46/1/10/43, Mass Average Molecular Weight: 36000, and Acid Value of 66 mgKOH/g), and Methyl Ethyl Ketone Solution (Solid Content: 45%)): 12.5 parts by mass
Propylene Glycol Monomethyl Ether Acetate Solution of Dipentaerythritol Hexaacrylate (DPHA, manufactured by Nippon Kayaku Co., Ltd.) (76 Mass %): 1.4 parts by mass
Urethane-Based Monomer (Product Name: NK OLIGO UA-32P, manufactured by Shin Nakamura Chemical Co., Ltd.: Non-Volatile Content of 75%, and Propylene Glycol Monomethyl Ether Acetate: 25%): 0.68 parts by mass
Tripentaerythritol Octaacrylate (Product Name: V#802, manufactured by OSAKA ORGANIC CHEMICAL INDUSTRY LTD.): 1.8 parts by mass
Diethyl Thioxanthone: 0.17 parts by mass
2-(Dimethyl Amino)-2-[(4-Methyl Phenyl) Methyl]-1-[4-(4-Morphonyl) Phenyl]-1-Butanone (Product Name: Irgacure 379, manufactured by BASF SE): 0.17 parts by mass
Dispersing Agent (Product Name: SOLSPERSE 20000, manufactured by Nitto Denko Corporation): 0.19 parts by mass
Surfactant (Product Name: MEGAFAC F-780F, manufactured by DIC Corporation): 0.05 parts by mass
Methyl Ethyl Ketone: 23.3 parts by mass
Propylene Glycol Monomethyl Ether Acetate: 59.8 parts by mass

Furthermore, the viscosity of the coating liquid W1 for forming an insulating layer at 100° C. after a solvent was removed therefrom was 4,000 Pa·sec.

The front plate attached with a white decorative material, a light shielding layer, and a first transparent electrode pattern was washed, and the transfer film W1 for forming an insulating layer from which the protective film was removed was laminated thereon (Substrate Temperature: 100° C., Rubber Roller Temperature of 120° C., Line Pressure of 100 N/cm, and Transport Speed of 2.3 m/minute). The temporary support was peeled off, and then, a distance between the surface of an exposure mask (a quartz exposure mask having a transparent electrode pattern) and the photocurable resin layer for etching was set to 100 μm, and pattern exposure was performed at an exposure amount of 30 mJ/cm² (an i line).

Next, a treatment was performed at 33° C. for 60 seconds by using a triethanol amine-based developer (a liquid in which T-PD2 (Product Name, manufactured by Fujifilm Corporation) containing 30 mass % of triethanol amine was diluted 10 times with pure water), a treatment was performed at 25° C. for 50 seconds by using a sodium carbonate/sodium hydrogen carbonate-based developer (a liquid in which T-CD1 (Product Name, manufactured by Fujifilm Corporation) was diluted 5 times with pure water), a treatment was performed at 33° C. for 20 seconds by using a surfactant-containing washing liquid (a liquid in which T-SD3 (Product Name, manufactured by Fujifilm Corporation) was diluted 10 times with pure water), and the residue was removed by a rotary brush and an ultra high pressure washing nozzle, and a postbaking treatment was further performed at 230° C. for 60 minutes, and thus, a front plate was obtained in which the white decorative material, the light shielding layer, the first transparent electrode pattern, and the insulating layer pattern were formed.

<Formation of Second Transparent Electrode Pattern>

(Formation of Transparent Electrode Layer)

As with the formation of the first transparent electrode pattern, the front plate in which the white decorative material, the light shielding layer, the first transparent electrode pattern, and the insulating layer pattern were formed was subjected to a DC magnetron sputtering treatment (Conditions: Temperature of Substrate of 50° C., Argon Pressure of 0.13 Pa, and Oxygen Pressure of 0.01 Pa), an ITO thin film having a thickness of 80 nm was formed, and thus, a front plate was obtained in which the white decorative material, the light shielding layer, the first transparent electrode pattern, the insulating layer pattern, and the transparent electrode layer were formed. The surface resistance of the ITO thin film was 110Ω/.

As with the formation of the first transparent electrode pattern, a front plate was obtained in which the white decorative material, the light shielding layer, the first transparent electrode pattern, the insulating layer pattern, the transparent electrode layer, and the photocurable resin layer pattern for etching were formed by using the transfer film E1 for etching (Postbaking Treatment; 130° C. for 30 minutes).

Further, as with the formation of the first transparent electrode pattern, etching (30° C. for 50 seconds) was performed, and the photocurable resin layer for etching was removed (45° C. for 200 seconds), and thus, a front plate was obtained in which the white decorative material, the light shielding layer, the first transparent electrode pattern, the insulating layer pattern, and second transparent electrode patterns disposed over both regions of the non-contact surface of the front plate and the surface of the light shielding layer on a side opposite to the front plate as illustrated in FIG. 5 were formed.

<Formation of Conductive Element Different from First Transparent Electrode Pattern and Second Transparent Electrode Pattern>

As with the formation of the first transparent electrode pattern and the second transparent electrode pattern, a front plate in which the white decorative material, the light shielding layer, the first transparent electrode pattern, the insulating layer pattern, and the second transparent electrode pattern were formed was subjected to a DC magnetron sputtering treatment, and thus, a front plate was obtained in which an aluminum (Al) thin film having a thickness of 200 nm was formed.

As with the formation of the first transparent electrode pattern and the second transparent electrode pattern, a front plate in which the white decorative material, the light shielding layer, the first transparent electrode pattern, the insulating layer pattern, the second transparent electrode pattern, the aluminum thin film, and the photocurable resin layer pattern for etching were formed was obtained by using the transfer film E1 for etching (Postbaking Treatment; 130° C. for 30 minutes).

Further, as with the formation of the first transparent electrode pattern, etching (30° C. for 50 seconds) was performed, and the photocurable resin layer for etching was removed (45° C. for 200 seconds), and thus, a front plate was obtained in which the white decorative material, the light shielding layer, the first transparent electrode pattern, the insulating layer pattern, the second transparent electrode pattern, and a conductive element different from the first transparent electrode pattern and the second transparent electrode pattern were formed.

<Formation of Transparent Protective Layer>

As with the formation of the insulating layer, the transfer film W1 for forming an insulating layer from which the protective film was removed was laminated on the front plate in which the white decorative material, the light shielding layer, the first transparent electrode pattern, the insulating layer pattern, the second transparent electrode pattern, and a conductive element different from the first transparent electrode pattern and the second transparent electrode pattern were formed, and the temporary support was peeled off, and then, front exposure was performed at an exposure amount of 50 mJ/cm² (an i line) without using an exposure mask, development, a postexposure treatment (1,000 mJ/cm²) and a postbaking treatment were performed, and thus, a front plate was obtained in which the insulating layer (the transparent protective layer) was laminated to cover all of the white decorative material, the light shielding layer, the first transparent electrode pattern, the insulating layer pattern, the second transparent electrode pattern, and the conductive element different from the first transparent electrode pattern and the second transparent electrode pattern as illustrated in FIG. 5. The obtained front plate is able to be used as an electrostatic capacitance type input device.

<Preparation of Image Display Device (Touch Panel)>

The front plate (the electrostatic capacitance type input device) manufactured in advance was bonded to a liquid crystal display element manufactured by a method disclosed in paragraphs [0097] to [0119] of JP2009-47936A, and thus, an image display device of Example 121 including the electrostatic capacitance type input device as a constituent was prepared by a known method.

<Total Evaluation of Front Plate and Image Display Device>

In each step described above, in the front plate (the electrostatic capacitance type input device) in which the white decorative material, the light shielding layer, the first transparent electrode pattern, the insulating layer pattern, the second transparent electrode pattern, and the conductive element different from the first transparent electrode pattern and the second transparent electrode pattern were formed, the opening portion and the back surface were not contaminated, the washing was easily performed, and other members were not contaminated.

In addition, a pin hole was not generated in the white decorative material, and whiteness and unevenness did not occur. Similarly, a pin hole was not generated in the light shielding layer, and light shielding properties were excellent.

Then, there was no problem in the conductivity of each of the first transparent electrode pattern, the second transparent electrode pattern, and the conductive element different from the first transparent electrode pattern and the second transparent electrode pattern, and insulating properties were provided between the first transparent electrode pattern and the second transparent electrode pattern.

Further, a defect such as air bubbles did not occur in the transparent protective layer, and an image display device having excellent display properties and excellent operability was obtained.

### Explanation of References

1: substrate (film substrate, only film substrate may be front plate)
1′: glass (cover glass, only cover glass may be front plate, and laminate of substrate and glass may be front plate)
2a: white decorative material
2b: light shielding layer
2c: tilt portion
3: conductive layer (first transparent electrode pattern)
3a: pad portion
3b: connection portion
4: conductive layer (second electrode pattern)
5: insulating layer
6: conductive layer (other conductive element)
7: transparent protective layer
8: opening portion
10: electrostatic capacitance type input device
11: reinforced glass
C: first direction
D: second direction

What is claimed is:

1. A pigment dispersion, containing:
a pigment dispersing agent having a partial structure denoted by General Formula 1 described below and a pigment adsorption portion in the same molecule;
a white pigment; and
any one of a hydrocarbon-based solvent, a ketone-based solvent, an ester-based solvent, and an alcohol-based solvent, 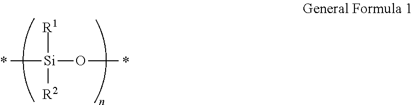
in General Formula 1, R¹ and R² each independently represent an alkyl group having 1 to 4 carbon atoms, an alkoxyl group having 1 to 2 carbon atoms, or a hydrogen atom, and n represents a natural number.

2. The pigment dispersion according to claim 1,
wherein the pigment dispersing agent has a copolymer which contains at least a copolymerization component having the partial structure denoted by General Formula 1 described above and a copolymerization component having the pigment adsorption portion, and a structure denoted by General Formula 2 described below, or a structure denoted by General Formula 3 described below,
(A¹-R⁴)ₗ—R³—(R⁵—P¹)ₘ General Formula 2
A¹-R⁵—P¹ General Formula 3
in General Formulas 2 and 3, R³ represents an (m+l)-valent organic linking group, R⁴ and R⁵ each independently represent a single bond or a divalent linking group, A¹ represents an organic group having a pigment adsorption portion or a hydrogen atom, P¹ represents a structure having the partial structure denoted by General Formula 1 described above, m represents 1 to 8, and 1 represents 1 to 10.

3. The pigment dispersion according to claim 1,
wherein a content of the partial structure denoted by General Formula 1 described above in the pigment dispersing agent is greater than or equal to 50 mass %.

4. The pigment dispersion according to claim 1,
wherein the pigment adsorption portion includes at least one portion selected from an acidic group, a group having a basic nitrogen atom, a urea group, a urethane group, a group having a coordinating oxygen atom, a hydrocarbon group having greater than or equal to 4 carbon atoms, a heterocyclic residue, an amide group, an alkoxy silyl group, an epoxy group, an isocyanate group, a hydroxyl group, and a thiol group.

5. The pigment dispersion according to claim 1,
wherein the white pigment is titanium oxide.

6. The pigment dispersion according to claim 1, further containing:
a silicone resin.

7. The pigment dispersion according to claim 1,
wherein the pigment dispersion is used for forming a white decorative material.

8. A white decorative material using the pigment dispersion according to claim 1.

9. A transfer material for forming a white decorative material, comprising:
a white colored layer using the pigment dispersion according to claim 1.

10. A substrate attached with a white decorative material, comprising:
the white decorative material according to claim 8; and
a substrate.

11. A touch panel, comprising:
the white decorative material according to claim 8.

12. An information display device, comprising:
the touch panel according to claim 11.
